(19) United States
(12) Patent Application Publication
(10) Pub. No.: US 2024/0046393 A1
(43) Pub. Date: Feb. 8, 2024

(54) INDIVIDUALIZED PATH RECOMMENDATION ENGINE BASED ON PERSONAL CHARACTERISTICS

(71) Applicant: Montana Butsch, Chicago, IL (US)

(72) Inventor: Montana Butsch, Chicago, IL (US)

(21) Appl. No.: 18/133,428

(22) Filed: Apr. 11, 2023

Related U.S. Application Data
(60) Provisional application No. 63/370,185, filed on Aug. 2, 2022.

(51) Int. Cl. G06Q 50/20

(52) U.S. Cl. CPC G06Q 50/2057; G06Q 50/2053

(57) ABSTRACT

A system enables users with an actionable pathway that supports personal agency in the identification and pursuit of hopes and dreams regarding their career. The system provides individualized recommendations of activities to pursue, college subjects to major in, which college to attend, and what career pathways to explore. In so doing, it maximizes their strengths, introduces them to unknown paths or careers, helps the user address personal shortcomings or weaknesses, and helps the user leverage structural systems to help ladder up.

### CROSS-REFERENCE TO RELATED APPLICATIONS

This is a U.S. Non-Provisional Patent Application that claims benefit to U.S. Provisional Patent Application Ser. No. 63/370,185 filed 2 Aug. 2022, which is herein incorporated by reference in its entirety.

### FIELD

The present disclosure is generally related to systems for individualized career counseling.

### BACKGROUND

In the educational world, it is widely understood that the earlier a child engages in formative experiences, the quicker they will master requisite skill sets that afford success later in life. However, the pressure on teens to constantly make forward-thinking decisions, frequently alone, is immense. Significant others in the family, community, and educational ecosystems often feel, or are, uninformed. Moreover, they can be ignorant of the potential ripple effects on lives and society when their loved one finds the “right” career pathway.

Career counseling services can help but are often underfunded, underemphasized, and sometimes incompetent or unmotivated. In the worst cases, a bad counselor can have a profoundly negative effect on the future of a child or young adult.

Automated career path services exist, but can be nebulous and unhelpful. Further, many of these tools and programs only use the most basic analysis techniques, simply giving students a few choices of a field of study based on their interests.

Teens and young adults need guidance on how to achieve their career goals. Human guidance can only be one part of a better guidance structure. Technology that uses artificial intelligence to create recommendations for career, college, and extracurricular activities is needed to optimize career planning.

It is with these observations in mind, among others, that various aspects of the present disclosure were conceived and developed.

### BRIEF DESCRIPTION OF THE DRAWINGS

FIG. 1 is a diagram showing a career path recommendation system according to various embodiments outlined herein;

FIG. 2 is a diagram showing a base module of the career path recommendation system of FIG. 1;

FIG. 3 is a diagram showing a profile engine of the career path recommendation system of FIG. 1;

FIGS. 4A-4F are a series of illustrations showing various user interfaces for generation of a profile of the user by the profile engine of FIG. 3;

FIG. 5 is a diagram showing a decision framework of the career path recommendation system of FIG. 1 that generates a set of recommendations for a user based on a profile of the user;

FIG. 6 is a diagram showing an activities engine of the decision framework of FIG. 5 that generates a set of recommended activities for a user based on a profile of the user;

FIGS. 7A-7D are a series of illustrations showing various user interfaces that display a set of recommended activities to a user based on an output of the activities engine of FIG. 6;

FIG. 8 is a diagram showing a study areas engine of the decision framework of FIG. 5 that generates a set of recommended study areas for a user based on a profile of the user;

FIGS. 9A-9C are a series of illustrations showing various user interfaces that display a set of recommended study areas to a user based on an output of the study areas engine of FIG. 8;

FIG. 10 is a diagram showing a careers engine of the decision framework of FIG. 5 that generates a set of recommended careers for a user based on a profile of the user;

FIG. 11 is an illustration showing a user interface that displays a set of recommended careers to a user based on an output of the careers engine of FIG. 10;

FIG. 12 is a diagram showing a learning institutions engine of the decision framework of FIG. 5 that generates a set of recommended learning institutions for a user based on a profile of the user;

FIG. 13 is an illustration showing a user interface that displays a set of recommended learning institutions to a user based on an output of the learning institutions engine of FIG. 12;

FIGS. 14A-14C are a series of illustrations showing various user interfaces of the career path recommendation system of FIG. 1 that enable a user to “work backwards” by receiving a profile and a target outcome of a user and providing recommendations that would help the user achieve the target outcome;

FIG. 15 is a simplified diagram showing functionality of a feedback engine of the career path recommendation system of FIG. 1;

FIG. 16 is a simplified diagram showing functionality of a training engine of the career path recommendation system of FIG. 1;

FIG. 17 is a simplified diagram showing a decision tree implementation of a machine learning model of the decision framework of FIG. 5;

FIG. 18 is a simplified diagram showing a neural network implementation of a machine learning model of the decision framework of FIG. 5;

FIG. 19 is a simplified diagram showing an example computing system for implementation of the career path recommendation system of FIG. 1; and

FIGS. 20A-20F are a series of process flow diagrams showing a general method for implementation of the career path recommendation system of FIG. 1.

Corresponding reference characters indicate corresponding elements among the view of the drawings. The headings used in the figures do not limit the scope of the claims.

### DETAILED DESCRIPTION

A computer-implemented system generates personalized recommendations for a user seeking educational goal and career advice based on characteristics of the user. The system obtains a profile of a user (e.g., a student) that includes personality information, demographics information, and other information about the user, and applies one or more machine-learning model formulated at a processor to generate a set of recommendations for the user based on the profile of the user. In one aspect, the profile of the user can include a personality profile, an academic grade profile, an emotional intelligence (EQ) profile, and a positive intelligence (PQ) profile. Optionally, the profile of the user can further include a demographics profile, a physical characteristic profile, a goals profile, and/or a preferences profile. The system generates a set of recommendations for the user based on the profile of the user, including a set of recommended activities (e.g., clubs, sports etc.), a set of recommended study areas (e.g., college majors, trade school study areas, etc.), a set of recommended careers, and a set of recommended learning institutions.

The system is operable to retrieve questions from a database for administration to a user. Responses to these questions from the user can be applied to obtain the profile for the user. The questions can include a set of personality questions that the system uses to obtain a personality profile of the student—in one implementation, the personality profile can include OCEAN scores for each of 5 OCEAN personality factors: openness, conscientiousness, extraversion, agreeableness, and neuroticism; in other implementations, other personality characterization methods may be employed. The set of recommendations may be made based on the OCEAN scores, among other factors such as emotional intelligence (EQ), positive intelligence (PQ), academic grades, and interests/preferences of the user.

In some examples, the set of recommendations can be dependent upon one another—for instance, if a particular study area is recommended for a student, then the set of recommended learning institutions for the student can include learning institutions that provide high-quality education with respect to the particular study area. In a further aspect, the one or more machine learning models can adjust the set of recommendations over time based on a trajectory of the user and based on feedback from other users.

Embodiments of the present disclosure will be described more fully hereinafter with reference to the accompanying drawings in which like numerals represent like elements throughout the several figures and in which example embodiments are shown. However, the claims' Embodiments may be embodied in many different forms and should not be construed as limited to the embodiments set forth herein. The examples set forth herein are non-limiting examples and are merely examples among other possible examples.

### Overview and General System

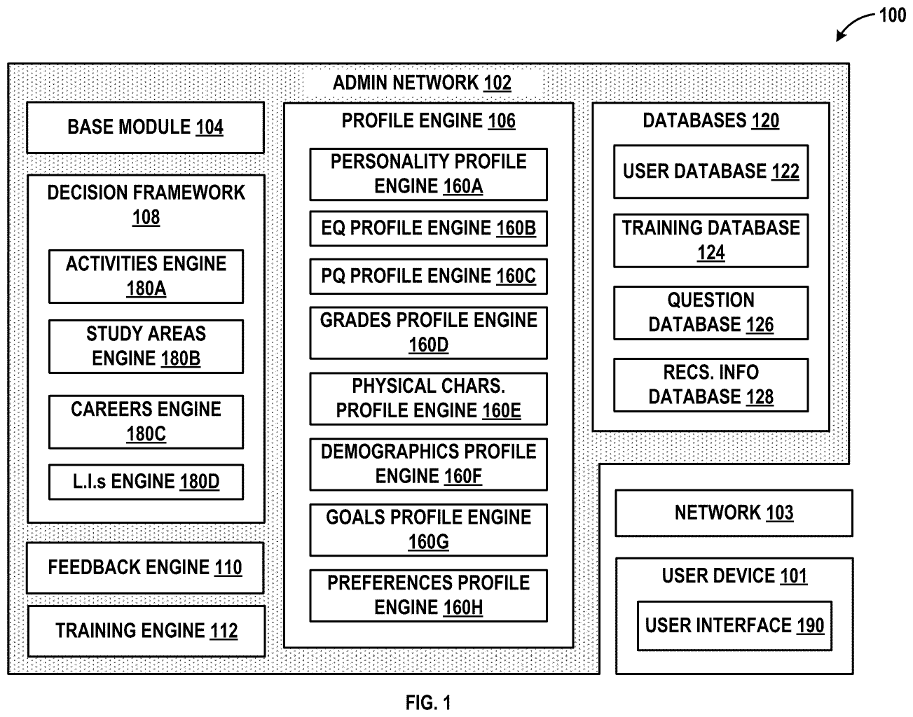

FIG. 1 is a general system diagram showing a computer-implemented career path recommendation system, referred to herein as “system 100”. This system 100 includes an admin network 102, which may be a computer or network that collects data from one or more user devices 101 over a network 103, such as the Internet. A user may interact with the system 100 through the user device 101, which can be a mobile device that implements aspects of the system 100 through a user interface 190 formulated within a mobile application, a web browser or other suitable method. The admin network 102 then uses the collected data to recommend activities, college options, and career paths to the user. The system 100 may include a base module 104, which can receive data from a user interface 190 at the user device 101 and initiate other modules in the admin network 102 based on the collected data. The base module 104 calls or otherwise directs the main functions for communication, information acquisition, profile construction, and recommendation generation. The base module 104 communicates with the user interface 190 to display information to the user at the user device 101. The user interface 190 can include various input fields where the user can provide responses to questions and provide feedback. The admin network 102 can be implemented at another device such as a server that communicates with the user device 101 over the network 103, retrieves questions for profile acquisition and updating, and communicates with one or more databases 120 to manage information associated with a plurality of users and recommendations (e.g., activities, study areas, careers, and learning institutions). The user device 101 can be a device such as a laptop, smartphone, tablet, computer, or smart speaker. The user interface 190 can embody an insight application, which may be an application on the user device 101 or a web browser. The user interface 190 can allow the user to access modules within the app in order to answer questions, view recommendations, and give feedback on the recommendations. The user interface 190 may connect to the admin network 102 directly or via the network 103 (e.g., cloud or Internet).

The system 100 can include a profile engine 106 that acquires information about the user to construct a profile of the user and store the profile at the one or more databases 120. The system 100 can further include a decision framework 108. The decision framework 108 can receive information about the user including the profile of the user and can apply one or more machine learning models to generate a set of recommendations for the user based on the profile . The system 100 can communicate the set of recommendations to the user through the user interface 190 at the user device 101.

### Overview and General System: Databases

The system 100 can include or otherwise communicate with the one or more databases 120 including a user database 122 that includes information such as the profile of the user, a training database 124 that includes training data for training one or more machine learning models of the decision framework 108, a question database 126 that includes questions and other directives for information acquisition, profile construction and feedback, and a recommendations information database 128 that includes information about each of a plurality of recommendations that can be considered by the system 100. The decision framework 108 of the system 100 can communicate with the recommendations information database 128 to generate the set of recommendations for the user.

The system 100 can store and access information indicative of the profile of the user at the user database 122. This information may include identifying information, the set of recommendations made by the decision framework 108, the user's answers to the questions in the question database 126, and any feedback from the user.

The system 100 can also include the training database 124, which may include data used to train the machine learning (ML) models used by the system 100 to make recommendations. The data in the training database 124 may be similar to the data in the user database 122, and can include labeled data and/or unlabeled data for supervised, unsupervised, or semi-supervised learning (e.g., to train the one or more machine learning models of the decision framework 108). Instead of (or in addition to) feedback data, the training database 124 may include data on other success or failure metrics that can be used to improve recommendations from the decision framework 108 over time. For example, the success or failure metrics can indicate if a person quit an activity, or if a person was ranked among the top of their college major, or if a person was terminated from their job or barred from practicing their career, etc. These metrics may be used to train the one or more machine-learning models of the decision framework 108 to make better recommendations. The system may include a training engine 112, which can train the one or more machine-learning models of the decision framework 108 to make recommendations using data from the training database 124. The training engine 112 may also use data from the user database 122 to train the one or more machine-learning models of the decision framework 108 if there is sufficient data.

The question database 126 can include questions used to evaluate a user's personality, emotional intelligence, positive intelligence, school grades, and physical characteristics. These questions may be accessed by the appropriate sub-engine of the profile engine 106 and presented to the user at the user interface 190.

The recommendations information database 128 can include information about various recommendations that may be made by the system 100. For example, the recommendations information database 128 can include information about various activities, study areas, careers, and/or learning institutions that may be considered for recommendations. Examples include prerequisites/necessary skills, correlation information (e.g., that correlate aspects of the profile of the user such as personality traits to one or more recommendations, that correlate study areas to careers, etc.), statistics, etc. This information may be accessed by the decision framework 108 when generating the set of recommendations.

### Overview and General System: Profile Engine

The system 100 can include a profile engine 106 that acquires information about the user for inclusion within the profile of the user. Information acquired by the profile engine 106 can be stored at the one or more databases 120 in association with the user. The profile engine 106 can include: a personality profile engine 160A that administers one or more personality questions to the user and stores results including information indicative of a personality profile of the user; an EQ profile engine 160B that administers one or more emotional intelligence questions to the user and stores results including information indicative of an EQ profile of the user; a PQ profile engine 160C that administers one or more positivity questions to the user and stores results including information indicative of a PQ profile of the user; and a grades profile engine 160D that requests academic grade information from the user and stores results including information indicative of an academic grade profile of the user. In some implementations, the profile engine 106 can further include at least one of: a physical characteristics profile engine 160E that requests physical characteristic information from the user and stores results including information indicative of a physical characteristics profile of the user, a demographics profile engine 160F that requests demographics information from the user and stores results including information indicative of a demographics profile of the user, a goals profile engine 160G that administers one or more goal-related questions to the user and stores results including information indicative of a goals profile of the user, and a preferences profile engine 160H that administers one or more preference-related questions to the user and stores results including information indicative of a preferences profile of the user. The personality profile, the EQ profile, the PQ profile, the academic grade profile, the demographics profile, the physical characteristics profile, the goals profile, and the preferences profile can be included within the profile of the user, stored at the user database 122 in association with the user, and can be used as input to the decision framework 108 to generate the set of recommendations for the user.

### Overview and General System: Decision Framework

The decision framework 108 can include a plurality of recommendation sub-engines. For example, the decision framework 108 can include an activities engine 180A, which may recommend activities such as basketball, judo, piano, journalism, etc. These recommendations are based on the profile of the user obtained by the profile engine 106 using questions answered by the user via the user interface 190. The decision framework 108 can also include a study areas engine 180B, which may recommend areas of study such as trades and college majors (e.g., physics, economics, medicine, history, etc.). The decision framework 108 can also include a careers engine 180C, which may recommend careers such as earth science, accounting, botany, hairstyling, etc. based on the profile of the user. The decision framework 108 can also include a learning institutions engine 180D that can recommend specific colleges or other schools based on the profile of the user.

### Overview and General System: Feedback Engine

The system 100 can include a feedback engine 110, which may allow users to give feedback on a recommendation. Feedback may be given by answering feedback questions which may be retrieved from the question database 126 on the admin network 102, and the answers may be sent to the user database 122 on the admin network 102. The feedback engine 110 may require some amount of verification that the user has reached a certain step towards the recommendation. For example, the user may only give feedback if the user has tried the recommended activity once, tried the recommended activity for 6 months, studied the recommended major for a year, worked in the recommended career field for 3 years, etc.

The system can include the network 103, e.g., the cloud or Internet, which may be a wired and/or wireless communication network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet, and relies on sharing of resources to achieve coherence and economies of scale, like a public utility, while third-party clouds enable organizations to focus on their core businesses instead of expending resources on computer infrastructure and maintenance

### Base Module

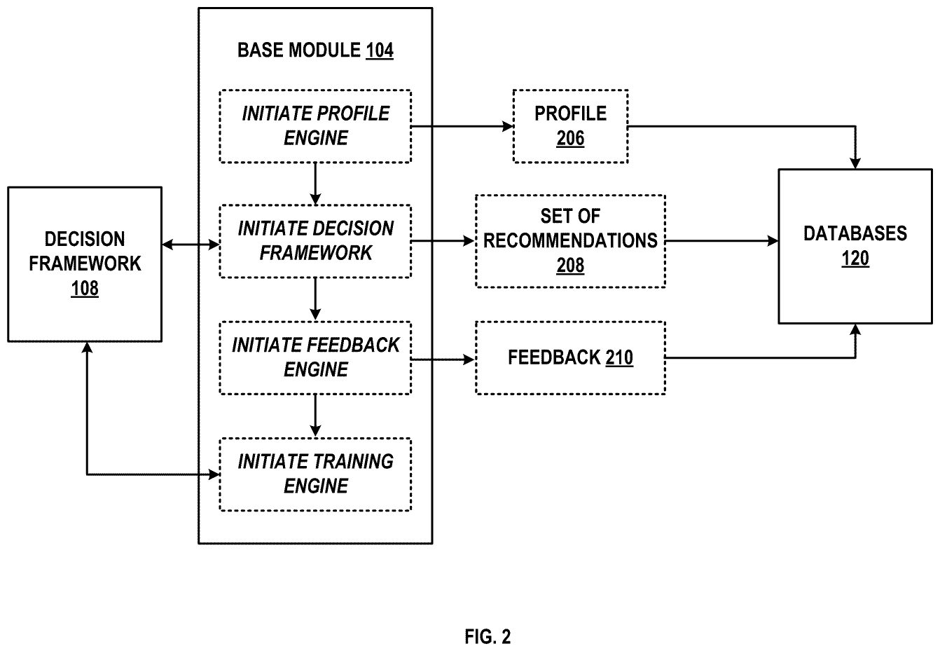

FIG. 2 displays the functioning of the “Base Module.” The process may begin with the base module 104 initiating the profile engine 106 (FIG. 1) to poll for data from the user device 101. The data may be answers to questions or feedback data The base module 104 may store the received data including a profile 206 at the one or more databases 120. The base module 104 may, for example, determine if the received data is a user's answer to one or more questions from the question database 126. If the data is question data, the base module 104 may initiate the decision framework 108 to generate a set of recommendations 208 for the user, the results of which can be saved at the one or more databases 120. Following generation of the set of recommendations 208 for the user based on the profile 206, the base module 104 may initiate the feedback engine 110 (FIG. 1) to obtain feedback 210 from the user regarding the set of recommendations 208. The base module 104 (or the feedback engine 110) can store the feedback 210 at the one or more databases 120. The base module 104 may initiate the training engine 112 (FIG. 1), which can use the feedback 210 and any additional data (e.g., success or failure data) to train the decision framework 108 to improve recommendations in the future.

### Profile Engine

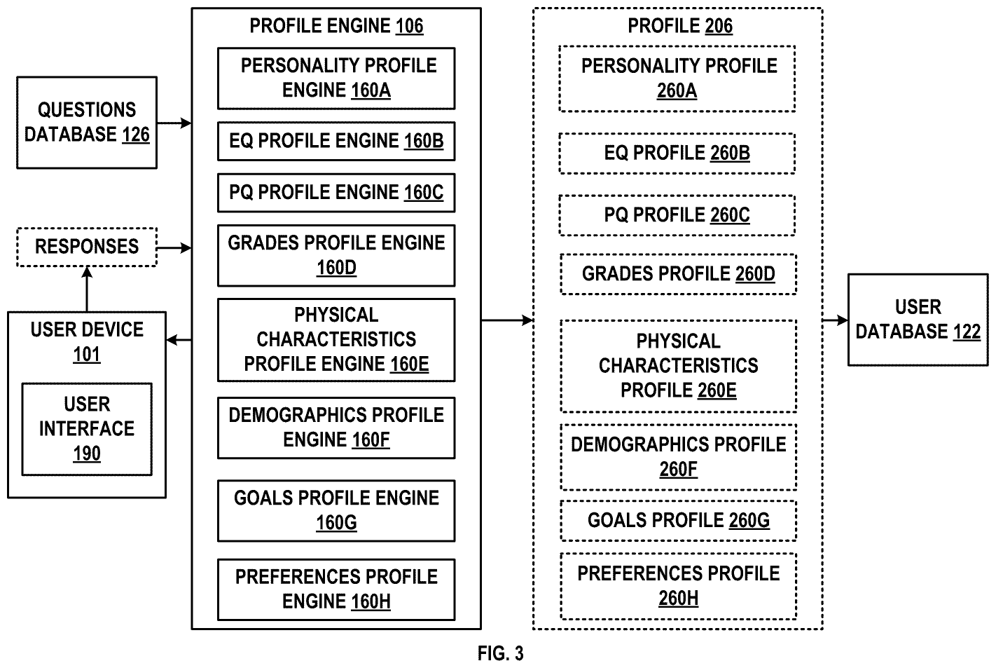

FIG. 3 shows the functioning of the profile engine 106. Steps taken by the profile engine 106 can include displaying the user interface 190 to the user at the user device 101 and registering the user with the system 100—this can involve, for example, creating a user instance for the user within the user database 122. The profile engine 106 can communicate with the question database 126 to retrieve a plurality of questions from the question database 126 for display at the user interface 190 to the user. The profile engine 106 can receive, at an input field of the user interface 190, responses to the plurality of questions from the user, and can store these responses at the user database 122. Based on the responses from the user, the profile engine 106 can generate the profile 206 for the user that characterizes the user according to personality, PQ, EQ, academic grades, and other information. Further, the profile engine 106 can be re-initiated based on feedback from the user and/or can be re-applied periodically over time (e.g., every few months) to ensure that the profile 206 of the user is up-to-date as the user naturally changes, acquires skills and experiences, and matures over time.

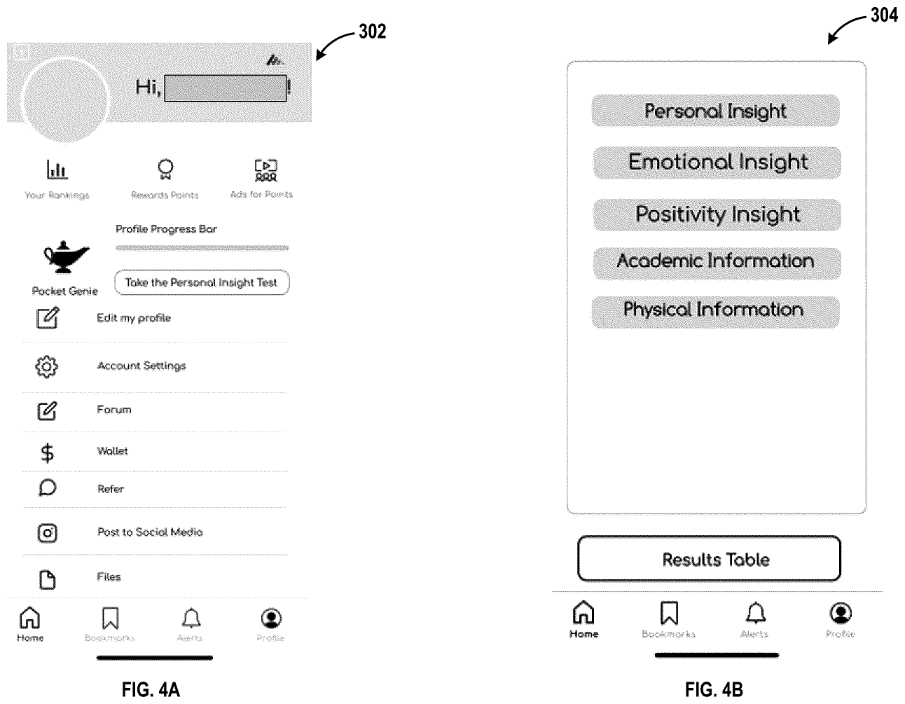

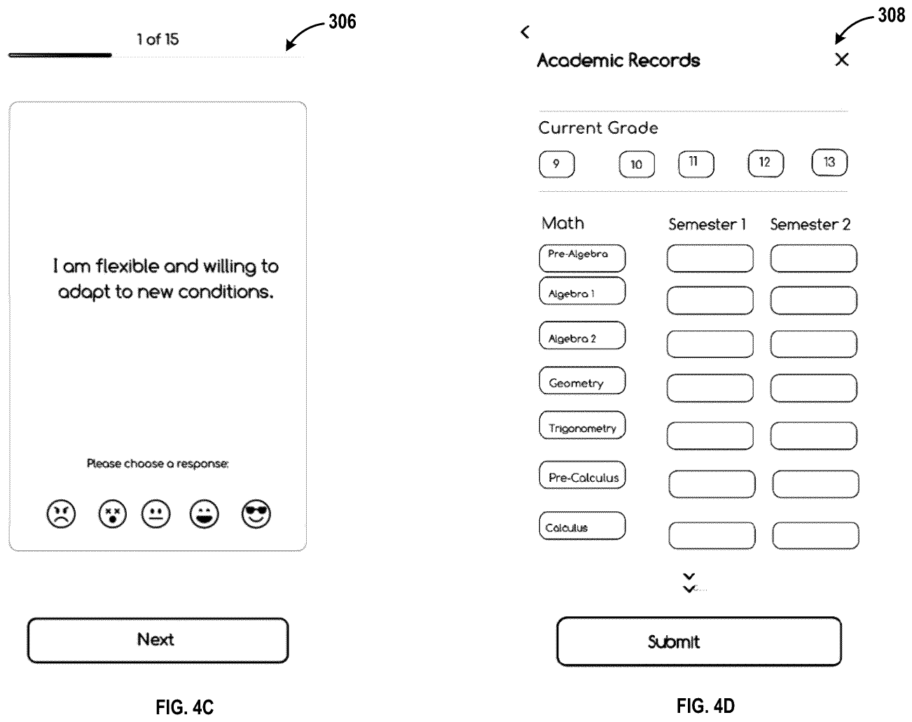

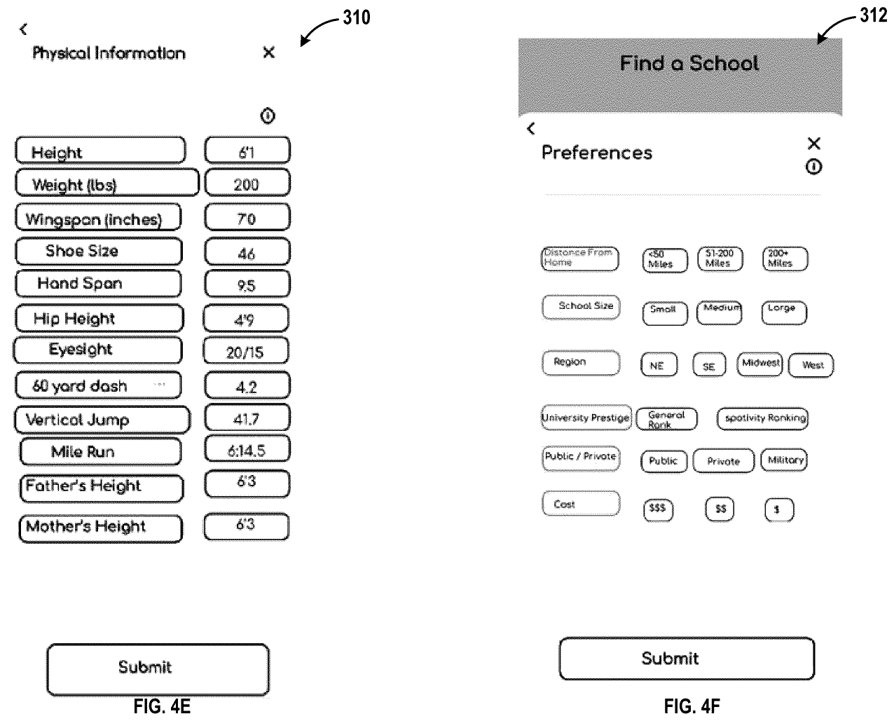

FIGS. 4A-4F show example user interfaces presented to the user at the user device 101. In particular, FIG. 4A shows a “profile” user interface 302 where a user can view and edit information within their profile. FIG. 4B shows a “polling” landing page 304 where a user can select a portion of the profile to complete (in the example, showing links to enter information related to personality, emotional intelligence, positive intelligence, academic information, and physical information).

### Profile Engine: Personality Profile

As discussed, the profile engine 106 can include the personality profile engine 160A that retrieves one or more personality questions from the question database 126, displays the one or more personality questions at the user interface 190, and receives responses from the user at the user interface 190. The personality profile engine 160A can analyze the responses from the user and generate a personality profile 260A for the user based on the responses. The personality profile engine 160A can determine one or more personality scores of the personality profile 260A of the user that quantify aspects of the personality of the user based on the responses to the one or more personality questions. In one example, the one or more personality scores can include OCEAN scores that quantify personality traits including as openness, conscientiousness, extraversion, agreeableness, and neuroticism. The one or more personality scores can also include other personality quantifiers such as, but not limited to, Myers-Briggs Type Indicator (MBTI), Enneagram, and/or DISC assessment.

A process applied at the personality profile engine 160A may begin with the personality profile engine 160A being initiated by the user. The user may select an option with the user interface 190, such as “Personality” or “Answer Personality Questions,”. The personality profile engine 160A may select a question from the question database 126 that is a personality question. These questions will assess the user's personality based on the 5-dimensional OCEAN personality type index. The personality profile engine 160A may determine if this user has an answer in the user database 122 for the selected question, and may determine if the answer has been provided recently (e.g., within the last 6 months). If the question has already been answered, the personality profile engine 160A may skip to another question or to evaluate the answers if all questions have been answered. Users may be able to edit previous answers if they choose. If the user has not already answered the question or wants to change their answer, or if the answer has not been verified recently, the personality profile engine 160A may prompt the user to answer the question. The options for the answer can be based on the question-answer format in the question database 126. For example, a personality question could have the user answer by agreeing or disagreeing with a statement such as “I see myself as extraverted and enthusiastic.” The user may have a range of answers from “Strongly Disagree” to “Strongly Agree”. The personality profile engine 160A may record the user's answer in the user database 122. The personality profile engine 160A may determine if there is another question in the question database 126 that is a personality question. If there is another personality question, the personality profile engine 160A may select the next question. If there are no other personality questions, the personality profile engine 160A may end.

### Profile Engine: EQ Profile and PQ Profile

The profile engine 106 can include the EQ profile engine 160B that retrieves one or more emotional intelligence questions from the question database 126, displays the one or more emotional intelligence questions at the user interface 190, and receives responses from the user at the user interface 190. The EQ profile engine 160B can analyze the responses from the user and generate the EQ profile 260B for the user based on the responses. The EQ profile engine 160B can determine one or more EQ scores of the EQ profile 260B of the user that quantify aspects of the emotional intelligence of the user based on the responses to the one or more EQ questions.

The profile engine 106 can include the PQ profile engine 160C that retrieves one or more positivity questions from the question database 126, displays the one or more positivity questions at the user interface 190, and receives responses from the user at the user interface 190. The PQ profile engine 160C can analyze the responses from the user and generate the PQ profile 260C for the user based on the responses. The PQ profile engine 160C can determine one or more PQ scores of the PQ profile 260C of the user that quantify aspects of the positivity of the user based on the responses to the one or more PQ questions.

The processes applied by either the EQ profile engine 160B or the PQ profile engine 160C may begin with the EQ profile engine 160B or the PQ profile engine 160C being initiated by the user. The user may select an option with the user interface 190, such as “EQ/PQ” or “Answer Emotion/Positivity Questions.” The EQ profile engine 160B or the PQ profile engine 160C may be initiated after the personality profile engine 160A has ended. The EQ profile engine 160B or the PQ profile engine 160C may select a question from the question database 126 that is an EQ or PQ question. These questions will assess the user's emotional intelligence, positive intelligence, or both. The EQ profile engine 160B or the PQ profile engine 160C may determine if this user has an answer in the user database 122 for the selected question. Users may be able to edit previous answers if they choose. If the user has not already answered the question or wants to change their answer, the EQ profile engine 160B or the PQ profile engine 160C may prompt the user to answer the question. The options for the answer are based on the question-answer format in the question database 126. For example, an EQ question is likely to have the user answer by agreeing or disagreeing with a statement such as “I am flexible and willing to adapt to new conditions.” The user may have a range of answers from “Disagree completely” to “Agree completely” and a PQ question is likely to have the user answer by agreeing or disagreeing with a statement such as “I am often Intrigued or fascinated” The user may have a range of answers from “Not At All” to “Extremely”. The EQ profile engine 160B or the PQ profile engine 160C may record the user's answer in the user database 122. The EQ profile engine 160B or the PQ profile engine 160C may determine if there is another question in the question database 126 that is an EQ or PQ question. If there is another EQ or PQ question, the EQ profile engine 160B or the PQ profile engine 160C may select the next question. If there are no other EQ or PQ questions, the EQ profile engine 160B or the PQ profile engine 160C may end.

FIG. 4C shows an example EQ question interface 306 where an EQ question and corresponding response field is displayed at the user device 101.

### Profile Engine: Grades Profile

The profile engine 106 can include the grades profile engine 160D that requests academic grade information from the user, displays multiple fields for entry of the academic grade information at the user interface 190 (e.g., course identifiers, when the course was taken, and associated letter or number grades that the user achieved in the course), and receives responses from the user at the user interface 190. The grades profile engine 160D can analyze the responses from the user and generate the grades profile 260D for the user based on the responses. The grades profile engine 160D enables quantification of one or more skills that the user may have and/or mastery of concepts demonstrated by the user based on the reported academic grades.

A process applied by the grades profile engine 160D may begin with the grades profile engine 160D being initiated by the user. The user may select an option with the user interface 190 such as “Grades” or “Answer Grades Questions.” The grades profile engine 160D may be initiated after the personality profile engine 160A, the EQ profile engine 160B and/or the PQ profile engine 160C have ended. The grades profile engine 160D may select a question from the question database 126 that is a grades question. These questions will assess the user's current or past grades in different school subjects. The grades profile engine 160D may determine if this user has an answer in the user database 122 for the selected question. Users may be able to edit previous answers if they choose. If the user has not already answered the question or wants to change their answer, the grades profile engine 160D may prompt the user to answer the question. The options for the answer are based on the question-answer format in the question database 126. For example, a grades question will likely have the user answer by responding with a letter grade to a question such as “what is your current grade in math?”. The user may have a range of answers from F to A+. The grades profile engine 160D may record the user's answer in the user database 122. The grades profile engine 160D may determine if there is another question in the question database 126 that is a grades question. If there is another grade question, the grades profile engine 160D may select the next question. If there are no other grade questions, the grades profile engine 160D may end.

In some implementations, the grades profile engine 160D may be operable to import grades from a school portal or through another method. This may be easier on the user, as they could bypass the time-consuming process of entering each course and grade received by hand, and can also ensure that the grades recorded within the grades profile 260D are accurate with respect to transcripts that a college or other learning institution may receive from the user's school in the future. Further, this may avoid ambiguity that could arise from differences or confusion in course identifiers and standards associated with each. In addition, information imported into the grades profile 260D from a school portal may include additional contextual information such as comments from the instructor, quarterly checkpoint grades, and other information. Written comments from the instructor can, for example, be subjected to natural language processing methods to extract concepts and add context to the profile 206 of the user.

FIG. 4D shows an example grades user interface 308 where a user can enter information related to their grades in individual subjects.

### Profile Engine: Physical Characteristics Profile

The profile engine 106 can include the physical characteristics profile engine 160E that requests physical characteristics information from the student and/or retrieves physical characteristics questions from the question database 126, displays multiple fields for entry of the physical characteristics information and responses to the physical characteristics questions at the user interface 190 (e.g., “How tall are you?” “How tall are your parents?” “How many push-ups can you reliably complete?” “How long does it take you to run 300 yards?” “How long does it take you to run a mile?”), and receives responses from the user at the user interface 190. The physical characteristics profile engine 160E can analyze the responses from the user and generate the physical characteristics profile 260E for the user based on the responses. The physical characteristics profile engine 160E enables quantification of one or more physical skills and/or attributes that the user may have based on the reported physical characteristics—these factors may be relevant for generating recommendations for activities such as sports, as well as for generating career recommendations for physically-intensive occupations such as athletes and first responders.

A process applied by the physical characteristics profile engine 160E may begin with the physical characteristics profile engine 160E being initiated by the user. The user may select an option with the user interface 190, such as “Physical Characteristics” or “Answer Physical Characteristics Questions.” The physical characteristics profile engine 160E may be initiated after the personality profile engine 160A, EQ profile engine 160B, PQ profile engine 160C, and/or grades profile engine 160D have ended. The physical characteristics profile engine 160E may select a question from the question database 126 that is a physical characteristics question. These questions will assess the user's physical characteristics, such as height, weight, physical condition, whether the user has any disabilities, etc. The physical characteristics profile engine 160E may determine if this user has an answer in the user database 122 for the selected question. If the question has already been answered, the physical characteristics profile engine 160E may skip. Users may be able to edit previous answers if they choose. If the user has not already answered the question or wants to change their answer, the physical characteristics profile engine 160E may prompt the user to answer the question. The options for the answer can be based on the question-answer format in the question database 126. For example, a physical characteristics question is likely to have the user answer by responding with a numerical value to a question such as “what is your current height in inches?”. The user may only be able to answer in realistic values such as between 20 and 100. The physical characteristics profile engine 160E may record the user's answer in the user database 122. The physical characteristics profile engine 160E may determine if there is another question in the question database 126 that is a physical characteristics question. If there is another physical characteristics question, the physical characteristics profile engine 160E may select the next question. If there are no other physical characteristics questions, the physical characteristics profile engine 160E may end.

FIG. 4E shows an example physical characteristics user interface 310 where a user can enter information related to their physical characteristics.

### Profile Engine: Demographics Profile

The profile engine 106 can include the demographics profile engine 160F that requests demographics information from the student and/or retrieves demographics questions from the question database 126, displays multiple fields for entry of the demographics information and responses to the demographics characteristics questions at the user interface 190, and receives responses from the user at the user interface 190. The demographics profile engine 160F can analyze the responses from the user and generate the demographics profile 260F for the user based on the responses. The demographics profile engine 160F enables quantification of information such as location and background of the user that may be relevant for generating recommendations for activities and learning institutions. For example, a user who identifies as Navajo may be eligible for scholarships and/or participation in various clubs and academic societies due to their heritage. In another example, location and/or economic information reported by a user may be relevant for recommending learning institutions for the user.

### Profile Engine: Goals Profile

The profile engine 106 can include the goals profile engine 160G that retrieves one or more goal-related questions from the question database 126, displays the one or more goal-related questions at the user interface 190, and receives responses from the user at the user interface 190. The goals profile engine 160G can analyze the responses from the user and generate the goals profile 260G for the user based on the responses. The goals profile engine 160G can help determine relevancy factors for the set of recommendations for the user—for example, a user may express that their goals may include outcomes such as landing a particular job, achieving a particular income level, attending a prestigious college, and graduating with little to no debt. Other goals may include, for example, a desire to travel, take care of family, and/or participate in humanitarian efforts. Goals expressed by the user may be relevant for recommending activities, study areas, careers, and learning institutions.

### Profile Engine: Preferences Profile

The profile engine 106 can include the preferences profile engine 160H that retrieves one or more preferences related questions from the question database 126, displays the one or more preferences questions at the user interface 190, and receives responses from the user at the user interface 190. The preferences profile engine 160H can analyze the responses from the user and generate the preferences profile 260H for the user based on the responses. Preferences profile engine 160H can help determine relevancy factors for the set of recommendations for the user—for example, a user may express preferences about college prestige, location (e.g., distance from home, general region, weather preferences), cost (e.g., can include scholarship availability and tuition cost), attributes (e.g., historically black, technology-focused, Ivy league, etc.) and type (e.g., private, public, military, religious, etc.). Preferences may also include items pertaining to activities, study fields, and careers—for example, a user may indicate that they want a more “hands-on” career, that they may enjoy playing a certain genre of music, or may want to play a particular sport in college. The preferences profile engine 160H may provide one or more fields where a user can enter comments—these comments can be subjected to natural language processing methods to extract concepts and add context to the profile 206 of the user.

FIG. 4F shows an example preferences user interface 312 where a user can enter information related to their preferences for selecting a learning institution.

### Decision Framework

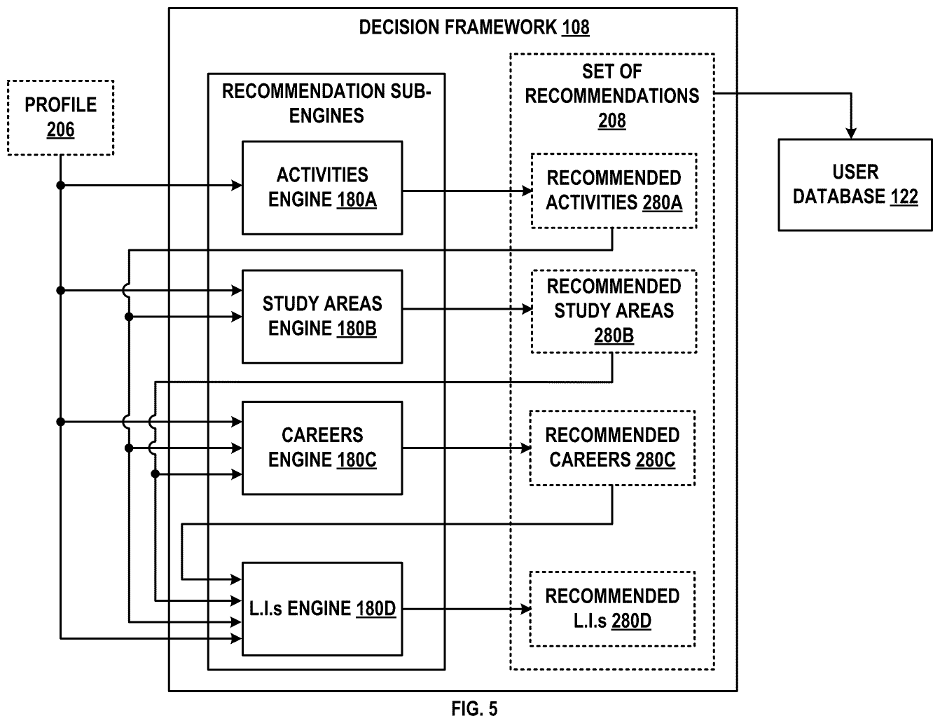

With additional reference to FIG. 5, the profile 206 of the user, including personality profile 260A, the EQ profile 260B, the PQ profile 260C, the grades profile 260D, the physical characteristics profile 260E, the demographics profile 260F, the goals profile 260G, and the preferences profile 260H can be used as input to the decision framework 108 to generate the set of recommendations 208 for the user. As discussed, the decision framework 108 receives information indicative of the profile 206 of the user and determines the set of recommendations 208 for the user based on the profile 206 of the user. The decision framework 108 includes one or more recommendation sub-engines that collectively generate the set of recommendations 208 for the user based on the profile 206 of the user, including the activities engine 180A that generates the set of recommended activities 280A, the study areas engine 180B that generates the set of recommended study areas 280B, the careers engine 180C that generates the set of recommended careers 280C, and the learning institutions engine 180D that generates the set of recommended learning institutions 280D. The set of recommendations 208 for the user can be stored at the user database 122.

The process may begin with the decision framework 108 being initiated by the user. The user may select an option with the user interface 190, such as “Recommendations” or “View Recommendations”. The base module 104 (FIG. 2) and/or decision framework 108 may search the user database 122 for the user's ID. The ID may be tied to an ID of the user device, such as an IP or MAC address. The user may need to log in with a username to access recommendations. The base module 104 may extract recommendations from the matching entry, and/or may initiate the decision framework 108 to generate the set of recommendations 208 based on the information present within the profile 206; the set of recommendations 208 may be re-generated periodically as the machine-learning models of the decision framework 108 are re-trained periodically and as new data becomes available. The set of recommendations 208 include the set of recommended activities 280A, the set of recommended study areas 280B, the set of recommended careers 280C and/or the set of recommended learning institutions 280D. The set of recommendations 208 can be displayed to the user via the user interface 190 displayed at the user device 101. The user may be able to interact with the recommendations. For example, the user may be able to select a recommendation to learn more information about it or give feedback on a recommendation. In another example, the user may be able to “select” one or more recommendations of the set of recommendations 208 as a “favorite”, which can indicate to the system 100 which recommendations of the set of recommendations 208 the student resonates with and/or feels is achievable for them.

### Decision Framework: Activities Engine

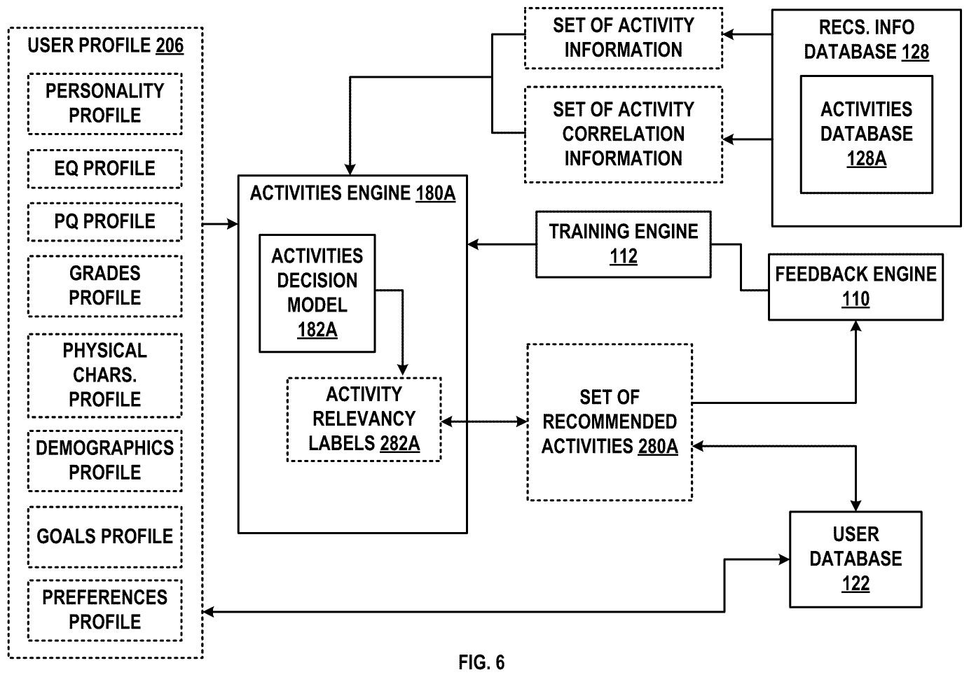

FIG. 6 displays the functioning of the activities engine 180A of the decision framework 108 that receives information indicative of the profile 206 of the user and generates the set of recommended activities 280A for the user based on the profile 206. The activities engine 180A can communicate with an activities database 128A of the recommendations information database 128 to retrieve, for example, a set of activity information and a set of activity correlation information, where the set of activity information can include information about a plurality of activities that may be available to a student and where the set of activity correlation information can include information about how a given activity correlates with one or more characteristics of a user and/or correlates with one or more study areas, one or more careers, and/or one or more learning institutions.

The activities engine 180A can receive information from the profile 206 of the user, including the personality profile 260A, the EQ profile 260B and the PQ profile 260C of the user. In some embodiments, the activities engine 180A can include an activities decision model 182A, which can be a machine-learning model trained to assign an activity relevancy label 282A to one or more activities for the user based on the profile 206 of the user. The activity relevancy label 282A can be a numeric relevancy value that might represent a probability that the associated activity would be relevant to the user, or that may represent a classification value (e.g., on a scale from 1-5 with 5 being most relevant, or a binary “yes” or “no”). Based on the personality profile 260A, the EQ profile 260B and the PQ profile 260C of the user, the activities engine 180A may initially construct the set of recommended activities 280A using the set of activity information and the set of activity correlation information.

The activities engine 180A may then receive additional information about the user, such as the physical characteristics profile 260E, and may modify the set of recommended activities 280A based on the additional information. For example, if a user is or is not athletic, then the activities engine 180A may modify an activity relevancy label for one or more sports activities and update the set of recommended activities 280A accordingly to include or exclude one or more sports based on the modified relevancy labels.

The activities engine 180A may then receive further information about the user, such as the grades profile 260D, demographics profile 260F, goals profile 260G, and/or preferences profile 260H, and may modify the set of recommended activities 280A based on this information. For example, if a user demonstrates math skill as evidenced by their grades profile 260D, then the activities engine 180A may modify a relevancy label for one or more math-related activities (such as robotics or another engineering club) and update the set of recommended activities 280A accordingly to include one or more math-related activities based on the modified relevancy labels. In another example, if the goals profile 260G or the preferences profile 260H indicates that the user enjoys working with children, then the activities engine 180A may modify a relevancy label for one or more related activities (such as tutoring or another club that involves volunteering with kids) and update the set of recommended activities 280A accordingly to include one or more activities based on the modified relevancy labels. In a further aspect, the demographics profile 260F may indicate that a user may be at a statistical advantage or disadvantage, and based on this information the activities engine 180A may modify an activity relevancy label of one or more activities that may improve a probability of success for the user—for example, a user attending school in a small farming town may be at a slight disadvantage due to lack of resources and world exposure, as such, the activities engine 180A may modify an activity relevancy label to emphasize certain sports or clubs that may allow the user to gain skills and travel in order to give them a competitive edge.

The process may begin with the activities engine 180A being initiated by the base module 104 and/or the decision framework 108. The activities engine 180A may select the user in the user database 122. The activities engine 180A may generate the set of recommended activities 280A based on the user's answers to personality questions as indicated within the profile 206 of the user. The questions may be analyzed to generate OCEAN scores for each of the 5 OCEAN personality factors: openness, conscientiousness, extraversion, agreeableness, and neuroticism. Then activity recommendations may be made based on the OCEAN scores. For example, a high score in openness may result in the activities engine 180A making the following activity recommendations. Sports: Archery, CrossFit, Jiu-Jitsu, Hapkido. Arts: Storytelling, Broadcasting, Culture, Drama. Mentoring: Drug and Alcohol Use Support, Field Trips, Advocacy, Home Visiting. Health: Self-Awareness, Nutrition, Body-Mind-Soul Development. Education: Career Exploration, Entrepreneurship, Foreign Language, Field Trips. Volunteerism: Multicultural Ministry, Outreach Events, Field Trips, Home Visiting. The activities engine 180A may, for example, make recommendations based on results that rate with the top and bottom 20% of the scale for each of the 5 factors, as the middle 60% may not show a clear association in either direction for a meaningful level of confidence. These 5 OCEAN factors, or the answers themselves, may be used as direct inputs into the activities decision model 182A, which can be a machine-learning model trained by the training engine 112. The activities engine 180A may alter the set of recommended activities based on the user's answers to EQ and PQ questions. The questions may be analyzed to generate a score for EQ and PQ. Activities may be added to the recommendations or removed based on these scores. For example, if the user scores between 81 and 90 EQ, the following activities would be added to the recommendations if not already recommended. Sports: Roller Skating, Kung Fu, Hockey. Arts: Ballet, Animation, Choreography. Mentoring: Counseling, Motivation. Health: Balance and Flexibility, Stepping, Therapy. Education: Current Events, Ethics, Reading Skills. Volunteerism: Crisis Management, Ex-Offender Assistance, Homelessness. Some score ranges may result in no changes to the generated recommendations, such as below 61 EQ and below 21 PQ. These EQ and PQ scores, or the answers themselves, may be used as direct inputs into the activities decision model 182A. The activities engine 180A may alter the activity recommendations based on the user's answers to school grade questions. For example, students consistently performing poorly in Math Subjects may have activities that require a keen understanding of Mathematics removed from some recommendations, such as Robotics. The user's grades may be used as direct inputs into the activities decision model 182A. The activities engine 180A may alter the activity recommendations based on the user's answers to physical characteristics questions. The user's physical characteristics will be used to change the physical activities recommended. Physical characteristics include height, weight, shoe size, etc.

Each physical characteristic may have a threshold for relevance. For example, the characteristic may be relevant if a user is in the top or bottom 20th percentile for height. A user in the top 20th percentile for height may have basketball, and volleyball added to their recommendations if not already recommended. A user in the bottom 20th percentile for height may have basketball and volleyball removed from their recommendations. Which physical characteristics are relevant, or the characteristics themselves may be used as direct inputs into the activities decision model 182A. The activities engine 180A may save the set of recommended activities 280A in the user database 122 associated with the selected user. The user can view these recommendations via the user interface 190.

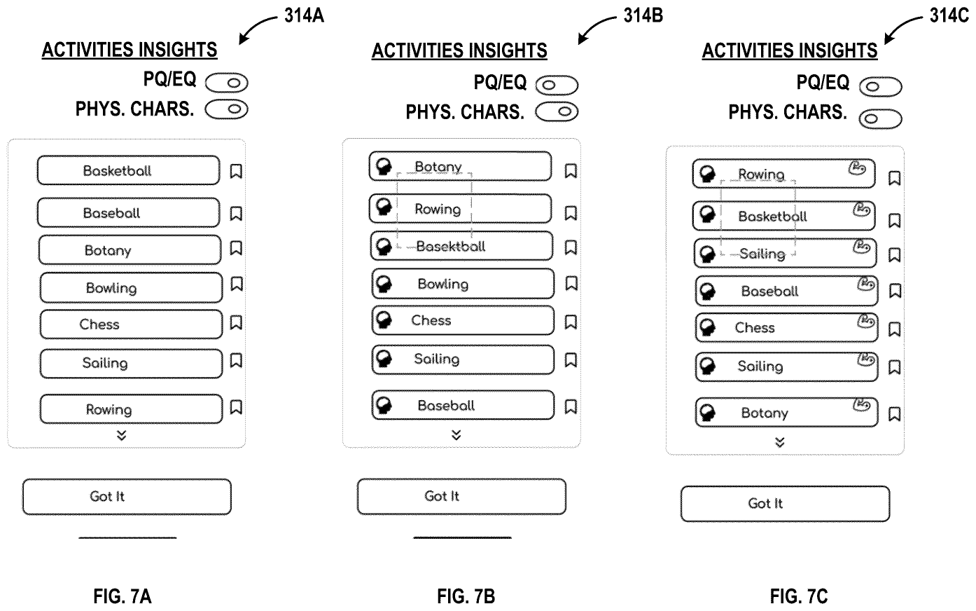

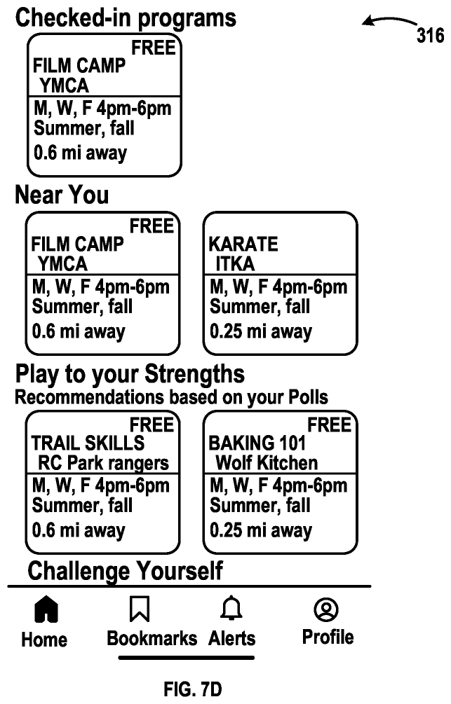

FIGS. 7A-7C show example activity result interfaces 314A, 314B and 314C that indicate the set of recommended activities 280A to the user at the user device 101. In some embodiments, as shown in FIGS. 7B and 7C, the user can toggle PQ/EQ and physical characteristics on or off to show alternative versions of the set of recommended activities 280A that include or ignore results influenced by PQ/EQ and physical characteristics as reflected within the profile 206 of the user.

In some embodiments, as shown in FIG. 7D, the system 100 can display local activities that the student may be able to participate in. FIG. 7D shows an example “local activity” interface 316 that shows information about various activities based on a location of the student and/or based on the set of recommended activities 280A.

### Decision Framework: Study Areas Engine

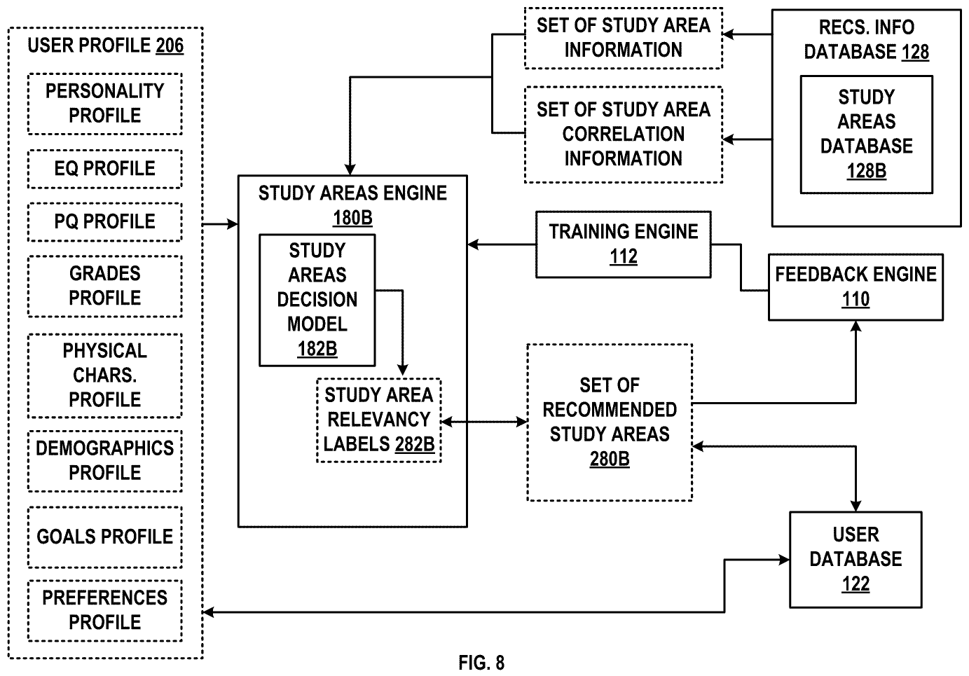

FIG. 8 shows functionality of the study areas engine 180B of the decision framework 108 that receives information indicative of the profile 206 of the user and generates the set of recommended study areas 280B for the user based on the profile 206. The study areas engine 180B can communicate with a study areas database 128B of the recommendations information database 128 to retrieve, for example, the set of study area information and the set of study area correlation information, where the set of study area information can include information about a plurality of study areas that may be available to a student and where the set of study area correlation information can include information about how a given study area correlates with one or more characteristics of a user and/or correlates with one or more activities, one or more careers, and/or one or more learning institutions.

For example, the set of study area information can include information about a study area such as an identifier and one or more keywords or other attributes about the study area, such as participation requirements or criteria, skills learned and/or required, general and/or specific fields associated with the activity (e.g., art, culture, music, engineering, math, etc.), availability (e.g., would the student need to travel to a specific school to study a particular subject, or can they go almost anywhere?), graduate or post-graduate availability, investment (e.g., a student wanting to study engineering may require a minimum of 4-year time and tuition investment, whereas a student wanting to study law may require a 4-year undergraduate degree before attending law school) and any other information that may be pertinent to a study area. Further, for example, the set of study area correlation information can include information about how each study area correlates with information that may be present in the profile 206 (such as compatible personality score ranges, preferences, etc.) and information about how each study area correlates with one or more activities, one or more careers (e.g., a user wishing to design computer hardware may want to consider degrees in electrical engineering or computer science), and/or one or more learning institutions (e.g., if a user wants to attend a prestigious arts school, then they may want to consider an arts major).

The study areas engine 180B can receive information from the profile 206 of the user, including the personality profile 260A of the user. In some embodiments, the study areas engine 180B can include a study areas decision model 182B, which can be a machine-learning model trained to assign a study area relevancy label 282B to one or more study areas for the user based on the profile 206 of the user. For example, based on the personality profile 260A of the user, the study areas engine 180B may initially construct the set of recommended study areas 280B using the set of study area information and the set of study area correlation information.

The study areas engine 180B may then receive additional information about the user, such as the grades profile 260D, the EQ profile 260B, the PQ profile 260C, the physical characteristics profile 260E, the demographics profile 260F, the goals profile 260G and the preferences profile 260H, and may modify the set of recommended study areas 280B based on the additional information. For example, if a user is good at math as evidenced by their grades profile 260D, then the study areas engine 180B may modify a study area relevancy label for one or more math-heavy study areas and update the set of recommended study areas 280B accordingly to include or exclude one or more study areas based on the modified study area relevancy labels. In a further aspect, the study areas engine 180B may receive activities information about the user, such as information about hobbies or clubs that the user enjoys and participates in and/or the set of recommended activities 280A (FIG. 5), and may use this information to modify a study area relevancy label for one or more related study areas and update the set of recommended study areas 280B accordingly. For example, if a user participates in a robotics club, then study area relevancy labels for one or more study areas related to robotics may be modified accordingly.

Table 1 shows a portion of an example “Grades to Majors” correlation matrix that may be included within the set of study area correlation information of the study areas database 128B, where study areas correlate to academic courses based on relative importance of grades—for example, for a journalism major, grades in writing and speech courses are of high importance (assigned a score of “3”) but grades in calculus are of minimal importance (assigned a score of “1”). Based on this example, if journalism was initially included within the set of recommended study areas 280B for a user based on their personality profile, but their grades profile indicate that they do not have sufficient writing skill based on how they perform in writing courses, then the study areas engine 180B may modify a study area relevancy label for the “journalism” study area and update the set of recommended study areas 280B accordingly to de-emphasize or exclude journalism from the set of recommended study areas 280B based on the modified study area relevancy labels. In one aspect, the study areas engine 180B can obtain a grade relevance factor from the set of study area correlation information and modify one or more study area relevancy labels for the user based on the grades profile 260D with respect to the grade relevance factor.

TABLE 1

| | GRADES IMPORTANCE (range: 1-3) | | | | | |
|---|---|---|---|---|---|---|
| Study Areas | Debate | Calculus | Statistics | Economics | Biology | . . . |
| Journalism | 3 | 1 | 1 | 1 | 1 | . . . |
| Biochemistry | 1 | 3 | 3 | 1 | 3 | . . . |
| Accounting | 1 | 2 | 2 | 2 | 1 | . . . |
| Psychology | 1 | 1 | 3 | 3 | 1 | . . . |
| . . . | . . . | . . . | . . . | . . . | . . . | . . . |

Study area and learning institution recommendations may be separate recommendations or may be associated. For example, the study areas engine 180B may recommend mathematics as a major at any learning institution because of the ubiquity of math but may only recommend botany as a major at learning institutions where botany has a history of leading to a realistic career path. Answers to questions may be analyzed to generate a score for each of the 5 OCEAN personality factors: openness, conscientiousness, extraversion, agreeableness, and neuroticism. Then recommendations may be made based on the scores. For example, a high score in openness may result in the system recommending communications as a major. The study areas engine 180B may only make recommendations based on results that rate with the top and bottom 20% of the scale for each of the 5 factors, as the middle 60% may not show a clear association in either direction for a meaningful level of confidence. These 5 OCEAN factors, or the answers themselves, may be used as direct inputs into the study areas decision model 182E. The study areas engine 180B may alter the set of recommended study areas based on the user's answers to EQ and PQ questions. The questions may be analyzed to generate a score for EQ and PQ. Majors may be added to the recommendations or removed based on these scores. For example, if the user scores between 101 and 110 EQ, the study areas engine 180B may add psychology to the list of recommended study areas. Some score ranges may result in no changes to the generated recommendations, such as below 61 EQ and below 21 PQ. These EQ and PQ scores, or the answers themselves, may be used as direct inputs into the study areas decision model 182B. The study areas engine 180B may alter the set of recommended study areas based on the user's answers to school grade questions. For example, a user with good grades in business, math, and computer-related courses may be recommended majors relevant to careers in business operations, business management, and entrepreneurship. The user's grades may be used as direct inputs into the study areas decision model 182B. The study areas engine 180B may alter the set of recommended study areas based on the user's answers to physical characteristics questions. The user's physical characteristics may not be considered unless there is a physical component to a recommended major or a reason physical characteristics may be relevant to study area selection, such as disability scholarships. Which physical characteristics are relevant, or the characteristics themselves may be used as direct inputs into the study areas decision model 182B. The study areas decision model 182B may save the set of recommended study areas 280B in the user database 122 associated with the selected user. The user can view these recommendations at the user interface 190.

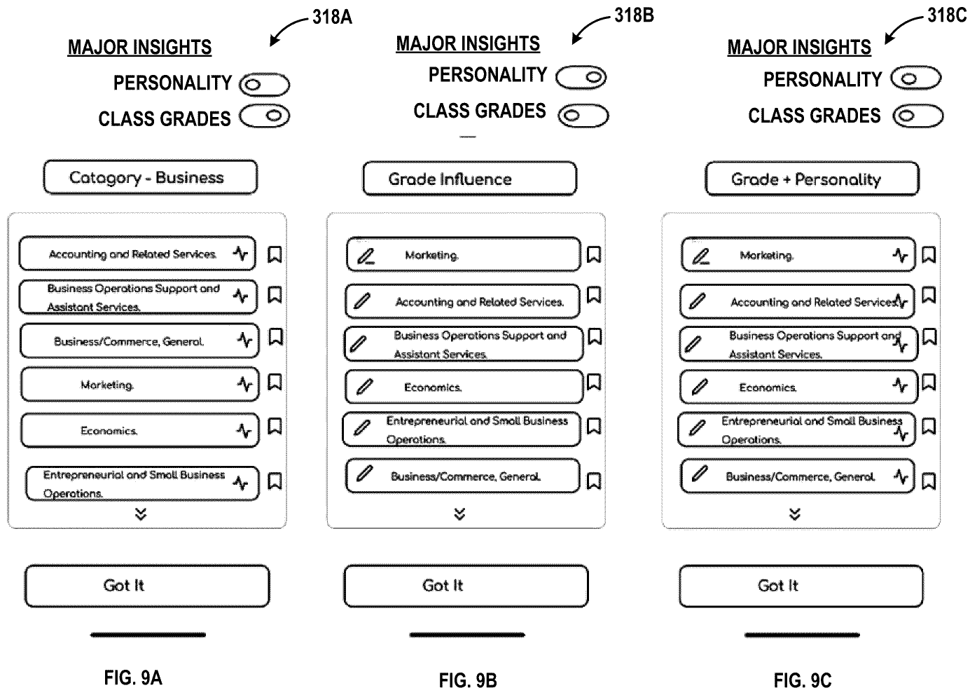

FIGS. 9A-9C show example activity result interfaces 318A, 318B and 318C that indicate the set of recommended study areas 280B to the user at the user device 101. In some embodiments, as shown in FIGS. 9B and 9C, the user can toggle personality and grades on or off to show alternative versions of the set of recommended study areas 280B that include or ignore results influenced by personality and grades as reflected within the profile 206 of the user.

### Decision Framework: Careers Engine

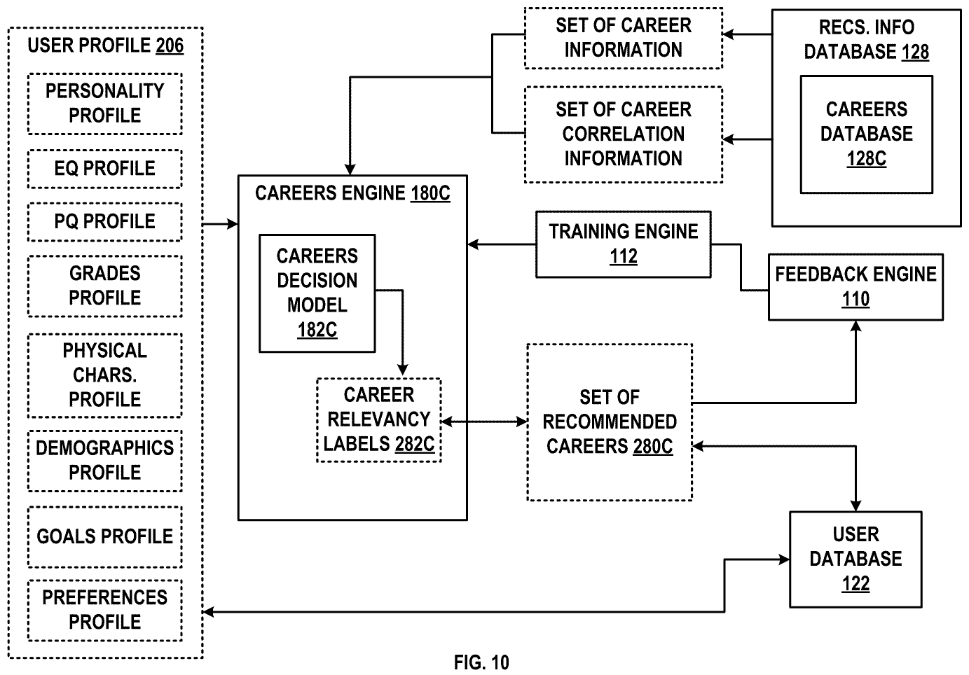

FIG. 10 shows the careers engine 180C of the decision framework 108 that receives information indicative of the profile 206 of the user and generates the set of recommended careers 280C for the user based on the profile 206. The careers engine 180C can communicate with a careers database 128C of the recommendations information database 128 to retrieve, for example, a set of career information and a set of career correlation information, where the set of career information can include information about a plurality of careers that may be available to a student and where the set of career correlation information can include information about how a given career correlates with one or more characteristics of a user and/or correlates with one or more activities, one or more study areas, and/or one or more learning institutions.

For example, the set of career information can include information about a career such as an identifier and one or more keywords or other attributes about the career, such as participation requirements or criteria, skills required, general and/or specific fields associated with the activity (e.g., art, culture, music, engineering, math, etc.), availability (e.g., is this an exclusive career path in a competitive market, such as if the student wants to be elected President, or is this career path relatively accessible or in high demand?), graduate/post-graduate/certification requirements (e.g., would the student be able to get the job they want with a bachelor's degree alone, or would they need additional schooling?), investment (e.g., a student wanting to be an engineer may only need a 4-year degree at minimum, whereas a student wanting to become a lawyer may require a 4-year undergraduate degree before attending law school, and would then need to pass at least one bar exam in order to practice) and any other information that may be pertinent to a career path. Further, for example, the set of career correlation information can include information about how each career correlates with information that may be present in the profile 206 and information about how each career correlates with one or more activities, one or more study areas, and/or one or more learning institutions.

The careers engine 180C can receive information from the profile 206 of the user, including the personality profile 260A of the user. In some embodiments, the careers engine 180C can include a careers decision model 182C, which can be a machine-learning model trained to assign a career relevancy label 282C to one or more careers for the user based on the profile 206 of the user. For example, based on the personality profile 260A of the user, the careers engine 180C may initially construct the set of recommended careers 280C using the set of career information and the set of career correlation information.

The careers engine 180C may then receive additional information about the user, such as the grades profile 260D, the EQ profile 260B, the PQ profile 260C, the physical characteristics profile 260E, the demographics profile 260F, the goals profile 260G and the preferences profile 260H, and may modify the set of recommended careers 280C based on the additional information. For example, if a user is good at math as evidenced by their grades profile 260D, then the careers engine 180C may modify a career relevancy label for one or more math-heavy careers and update the set of recommended careers 280C accordingly to include or exclude one or more careers based on the modified career relevancy labels. In a further aspect, the careers engine 180C may receive activities information about the user and/or study areas information about the user, such as information about hobbies or clubs that the user enjoys and participates in, information about a subject a user is or wants to minor in, and/or information about a subject that a student has taken classes towards and may use this information to modify a careers relevancy label for one or more related study areas and update the set of recommended careers 280C accordingly. For example, if a user participates in a robotics club, then career relevancy labels for one or more careers that employ skills that might have been learned due to participation in robotics may be modified accordingly. In another example, if a user is pursuing a technical degree as their major, but also has writing skills and/or shows deep interest in topics such as anthropology and history, then relevancy labels for one or more related careers may be modified accordingly—for example, the set of recommended careers 280C may be updated to include careers that involve technical writing or that could involve study of ancient technology.

Table 2 shows a portion of an example “Majors to Careers” correlation matrix that may be included with in the set of career correlation information, where careers correlate to majors based on applicability—for example, if a user pursues an accounting degree, then the set of recommended careers 280C can include careers within the fields of business, tax preparation and analysis, auditing, management, and mathematics. In one aspect, the careers engine 180C can obtain a study area relevance factor from the set of career correlation information and modify one or more career relevancy labels for the user based on the set of recommended study areas and/or based on a grades profile 260D (e.g., for students who have already selected a study area) with respect to the grade relevance factor.

TABLE 2

| | STUDY AREAS TO CAREERS (range: 0 or 1) | | | | |
|---|---|---|---|---|---|
| | | Biochem- | | Clinical, | |
| | Commu- | istry, | | Coun- | |
| | nication, | Bio- | Ac- | seling | |
| | Jour- | physics | counting | and | |
| | nalism, and | and | and | Applied | |
| | Related | Molecular | Related | Psy- | |
| CAREERS | Programs, Other | Biology | Services | chology | . . . |
| Campaign | 1 | 0 | 0 | 0 | . . . |
| Manager | | | | | |
| Research | 0 | 1 | 0 | 0 | . . . |
| Scientist | | | | | |
| Tax | 1 | 0 | 1 | 1 | . . . |
| Examiner | | | | | |
| . . . | . . . | . . . | . . . | . . . | . . . |

The careers engine 180C may generate the set of recommended careers 280C based on the college majors recommended to the user by the study areas engine 180B (FIG. 6). For example, if the user was recommended medicine as a major, the set of recommended careers may include careers strongly associated with a degree in medicine, such as a physician, surgeon, or pharmaceutical researcher. The careers engine 180C may alter the set of recommended careers 280C based on the user's answers to personality questions. The questions may be analyzed to generate a score for each of the 5 OCEAN personality factors: openness, conscientiousness, extraversion, agreeableness, and neuroticism. Then recommendations may be added or removed based on the scores. For example, a low score in conscientiousness may result in the careers engine 180C removing physician as a career recommendation. The careers engine 180C may, for example, make recommendations based on results that rate with the top and bottom 20% of the scale for each of the 5 factors, as the middle 60% may not show a clear association in either direction for a meaningful level of confidence. These 5 OCEAN factors, or the answers themselves, may be used as direct inputs into the careers decision model 182C. The careers engine 180C may alter the set of recommended careers 280C based on the user's answers to EQ and PQ questions. The questions may be analyzed to generate a score for EQ and PQ. Careers may be added to the recommendations or removed based on these scores. For example, if the user scores between 111 and 120 EQ, then pediatrician may be added to the recommendations if the recommendations already include physician. Some score ranges may result in no changes to the generated recommendations, such as below 61 EQ and below 21 PQ. These EQ and PQ scores, or the answers themselves, may be used as direct inputs into the careers decision model 182C. The careers engine 180C may alter the set of recommended careers 280C based on the user's answers to school grade questions. For example, students performing poorly in math may have careers that require an understanding of math removed from the recommendations, such as accounting. The user's grades may be used as direct inputs into the careers decision model 182C. The careers engine 180C may alter the set of recommended careers based on the user's answers to physical characteristics questions. The user's physical characteristics will be used to alter the physical careers recommended. Physical characteristics include height, weight, shoe size, etc. Each physical characteristic may have a threshold for relevance. For example, the characteristic may be relevant if a user is in the top or bottom 20th percentile for height. A user in the top 20th percentile for height may have astronaut removed recommendations due to astronaut height restrictions. A user in the bottom 20th percentile for eyesight or who are colorblind may have airplane pilot removed from their recommendations. Which physical characteristics are relevant, or the characteristics themselves may be used as direct inputs into the careers decision model 182C. The careers engine 180C may save the set of recommended careers 280C in the user database 122 associated with the selected user. The user can view these recommendations via the user interface 190.

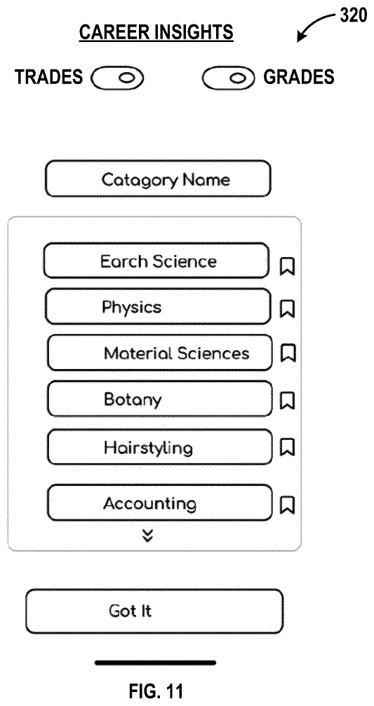

FIG. 11 shows an example career result interface 320 that indicates the set of recommended careers 280C to the user at the user device 101. In some embodiments, the user can toggle “grades” on or off to show alternative versions of the set of recommended careers 280C that include or ignore results influenced by grades as reflected within the profile 206 of the user. Further, the user can toggle “trades” on or off to show alternative versions of the set of recommended careers 280C that include or ignore trade results (e.g., refrigeration, plumbing, etc.).

### Decision Framework: Learning Institutions Engine

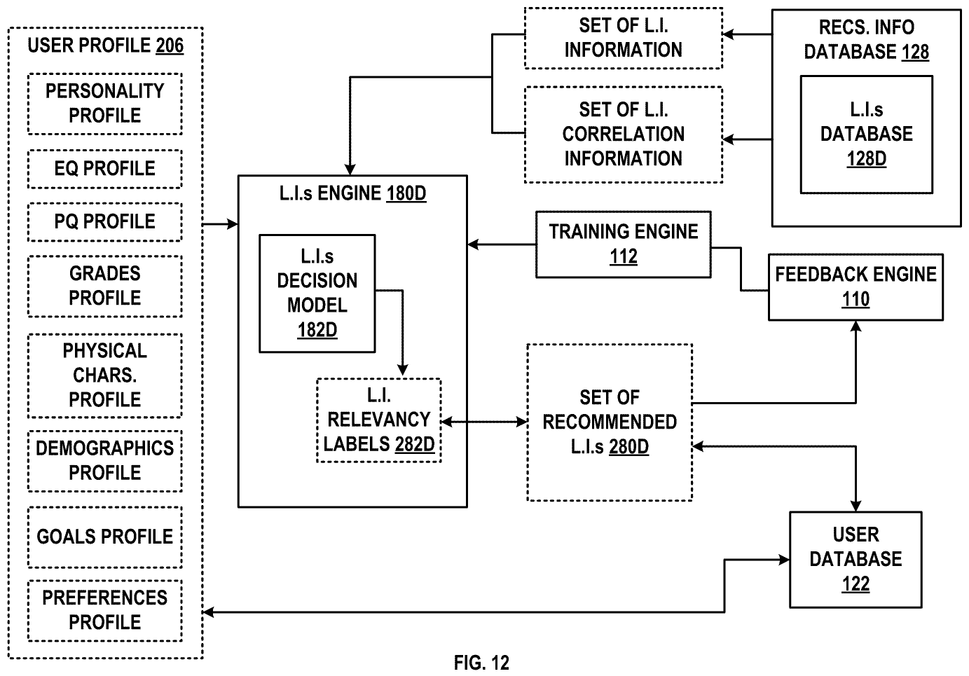

FIG. 12 shows the learning institutions engine 180D of the decision framework 108 that receives information indicative of the profile 206 of the user and generates the set of recommended learning institutions 280D for the user based on the profile 206. The learning institutions engine 180D can communicate with a learning institutions database 128D of the recommendations information database 128 to retrieve, for example, a set of learning institution information and a set of learning institution correlation information, where the set of learning institution information can include information about a plurality of learning institutions that may be available to a student and where the set of learning institution correlation information can include information about how a given learning institution correlates with one or more characteristics of a user and/or correlates with one or more activities, one or more study areas, and/or one or more careers.

The learning institutions engine 180D can receive information from the profile 206 of the user, including the preferences profile 260H of the user. In some embodiments, the learning institutions engine 180D can include a learning institutions decision model 182D, which can be a machine-learning model trained to assign a learning institution relevancy label 282D to one or more learning institutions for the user based on the profile 206 of the user. For example, based on the preferences profile 260H of the user, the learning institutions engine 180D may construct the set of recommended learning institutions 280D using the set of learning institution information. The learning institutions engine 180D may also modify one or more learning institution relevancy labels 282D and/or the set of recommended learning institutions 280D based on the personality profile 260A, the EQ profile 260B, the PQ profile 260C, the grades profile 260D, and/or the demographics profile 260F.

For example, the set of learning institution information can include information about a learning institution such as an identifier and one or more keywords or other attributes about the learning institution, such as type, size, accreditation status, public or private status, prestige, requirements and pre-requisites, general and/or specific fields associated with the learning institution (e.g., art, culture, music, engineering, math, etc.), acceptance rate, cost, sports and clubs offered, and any other information that may be pertinent to a learning institution. Further, for example, the set of learning institution correlation information can include information about how each learning institution correlates with information that may be present in the profile 206 (such as compatible personality score ranges, preferences, etc.) and information about how each learning institution correlates with one or more activities, one or more study areas, and/or one or more careers.

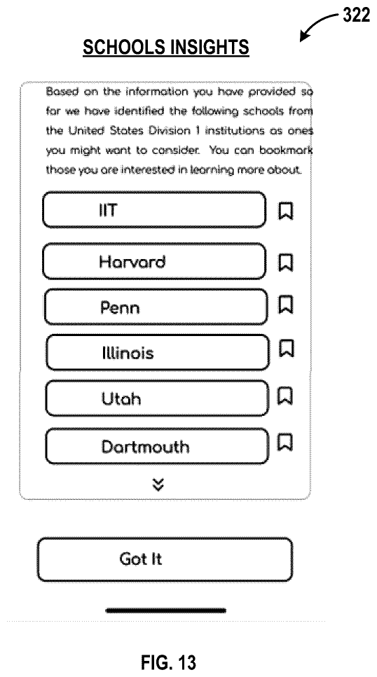

FIG. 13 shows an example learning institution result interface 322 that indicates the set of recommended learning institutions 280D to the user at the user device 101.

### Decision Framework: Additional Aspects

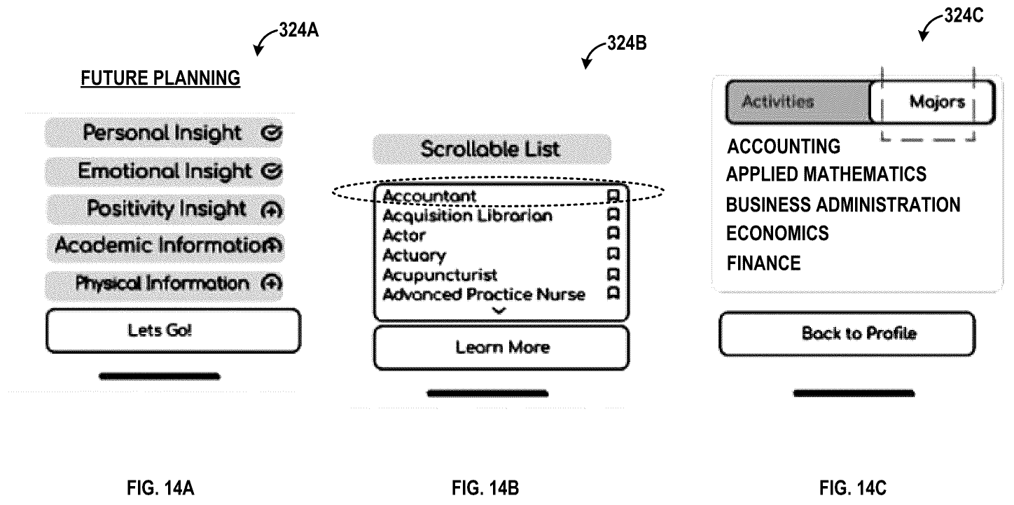

In a further aspect, as shown in FIGS. 14A-14C, the system 100 can be applied to “work backwards”, in that if a user has an outcome in mind or simply wants to see what may hypothetically be required to reach the outcome, then the system 100 can generate the set of recommendations that may help the user achieve the specified outcome (e.g., as opposed to simply telling the user what might be a good fit for them). For example, the goals profile captured by the profile engine 106 may indicate that a user wants to have a certain career in the future. The decision framework 108 can determine a set of recommendations that can maximize the chances of the user to achieve their career of choice. Suppose a user wants to become an astronaut in the future, but does not know what they should do in the meantime to better their chances of becoming one. The user may interact with the profile engine 106, which obtains information about the user including the user's grades and physical characteristics—in this example, the user may have excellent grades in physics, chemistry, and earth sciences, but may need to improve their math grades. Further, the user may be overweight as indicated by their physical characteristics profile. As a result, the decision framework 108 may receive information about the user's target outcome (astronaut), adjust relevancy labels and provide recommendations for activities and courses that could help improve the user's math grades and help them get in shape, as physical fitness and math skills are important traits for astronauts. The decision framework 108 may make this determination based on information within the recommendations information database 128 that describe fitness and math requirements for astronauts, as well as information describing attributes of individuals who have already become astronauts.

In another example, the system 100 may provide information to a user about one or more prerequisite courses that they may be able to take towards a study area that the user may want to target. The profile engine 106 can obtain information about activities and grades for the user, and the decision framework 108 may recommend one or more activities and/or courses that may help the user get on track or get ahead in their study area based on the profile of the user and based on information within the recommendations information database 128 that describe skills, prerequisites, and relative importance of course grades associated with the selected study area.

FIGS. 14A-14C show example “future planning” interfaces 324A, 324B and 324C that direct the user to generate the profile, provide a scrollable list for the user to select an occupation, and provide a listing of activities and majors to the user based on the selected occupation.

In a further example, the decision framework 108 may account for a time-aware trajectory of a user. For example, a user may first interact with the system 100 at age 12, where the user is still in middle school. At this age, the user may not have had the opportunity to take elective classes, as such, their academic record may not show any specialization in one or more topics that the user may be able to leverage. The user may also struggle with certain topics due to factors such as age, conditioning, and lack of world exposure. Over time, as the user interacts with the profile engine 106 during the following years, the user may demonstrate variations in their grades and interests and the set of recommendations for that user could change. If the user demonstrates rapid improvement in several completely different areas, then the decision framework 108 may account for an ability of the user to learn about many different topics very quickly as evidenced by information collected about the user over time, and may recommend activities, study areas, and career paths where the user may be able to leverage their ability as a “jack-of-all-trades”. Similarly, the system 100 may adjust physical characteristics of the user based on factors such as age, growth curve, and physical characteristics of their parents. Physical characteristics may also be considered in terms of likelihood that they may change—for example, most 18 year old users have less potential for height growth than most 12 year old users; in another example, significant weight loss can usually be more achievable than significant height gain for an 18 year old user, as such, the decision framework 108 may consider weight and other physical characteristics that are more likely to change over time with less importance than other physical characteristics that are somewhat “fixed”.

In another example, the decision framework 108 may account for nuances within a given topic and identify overarching skills of a user as evidenced by their performance with respect to different topics over time and as evidenced by trajectories and skills of similar users. This may be accomplished by constructing and training the one or more machine learning models of the decision framework 108 to consider time-aware trajectories of users. Further, the one or more machine learning models of the decision framework 108 may be constructed and trained in such a way that allows the decision framework 108 to identify connections between reported traits of a user that can reveal nuances of the user that may not be immediately identifiable.

For instance, a user may struggle with arithmetic but could still be gifted at visualizing patterns and abstract mathematical concepts. As a result, their grades in math during middle school where arithmetic skills are more important may be average or below average until they reach more abstract topics such as geometry, along with other topics such as chemistry and music where practical application of pattern recognition and visualization skills may be vital, during which their grades may improve (but still may suffer due to difficulties with arithmetic). The user may not even notice this ability in themselves, and may even consider themselves to be “bad at math”—this sort of thinking is a common drawback of current career guidance services where a student is pressed to make decisions based on their own perception of themselves and the limited information available to them. To address this, the profile engine 106 can retrieve and display questions that may help quantify hidden or otherwise latent skills of the user, and the decision framework 108 can examine the profile of the user to identify overarching skills and strengths that the user may have based on received responses to the questions. Based on the information within the profile of the user, the decision framework 108 may identify that the user seems to do well with one or more topics—for example, topics involving pattern recognition and abstract visualization. As a result, the system 100 may inform the user that they seem to have a pattern recognition skill and recommend that the user participates in activities such as chess, computer science, and robotics that may foster their pattern recognition abilities and help them overcome their deficits by learning how to use math in practical application.

In a further aspect, the decision framework 108 may be operable to account for contextualized experiences of the user to avoid, for example, taking responses at face value. The question database 126 may include questions that the profile engine 106 may administer to the user regarding grades, after-school jobs, and participation in clubs, as well as questions that add context to each. For example, a user who reports an uncharacteristically low grade in a topic they normally excel in may indicate one or more reasons for the low grade, such as: a bad or chronically unavailable instructor, disruption in home stability, economic stressors that required the user to spend more time at work and less time on studies, and/or an illness that may have prevented the user from operating at their best—this contextual information can indicate that their low grade does not necessarily reflect their skill level or interest in a topic. Other contextual information can be more informative as to which recommendations are suitable or unsuitable for the user—for example, the user may have received a lower grade because they have simply lost interest in the topic; this contextual information can be valuable as it reflects that the user may be better suited for other things, and may not necessarily reflect a deficit in the user's skill level or abilities that are related to the topic. This contextual information may be saved within the profile of the user and included within the inputs provided to the decision framework 108 to help develop a more complete characterization of the user and provide informed recommendations.

### Databases

Table 3 shows an example entry within the user database 122. The user database 122 may include the profile 206 of the user, user answers to questions, including feedback questions, and the set of recommendations 208 for that user. Each user may have a user ID which may be an internal identifier or may be an identifier of the user, such as a username.

TABLE 3

| | | | | | | | | | | Recommended | Recommended | |
|---|---|---|---|---|---|---|---|---|---|---|---|---|
| ID | Q1 | . . . | OCEAN scores | | | | | EQ | . . . | Activities | Study Areas | . . . |
| AB1234 | 7 | . . . | 5 | 2 | 2 | 5 | 6 | 65 | . . . | Track, theater, | Computer | . . . |
| | | | | | | | | | | martial arts | Science, visual | |
| | | | | | | | | | | [. . .] | arts [. . .] | |

| | | | | | | | | |
|---|---|---|---|---|---|---|---|---|
| . . . | . . . | . . . | . . . | . . . | . . . | . . . | . . . | . . . |

Table 4 shows an example entry within the question database 126. The question database 126 may contain questions used to evaluate a user's personality, emotional intelligence, positive intelligence, school grades, and physical characteristics, and can also include feedback questions. Each entry may include a question ID and the text of the question. Each entry may include the format of the answer. For example, for a question about the user's current letter grade in math, the only answers possible may be the letters A-F with a + or − sign. Each entry may also include a question type such as personality, emotional intelligence, positive intelligence, school grades, and physical characteristics.

TABLE 4

| | | | Question answer |
|---|---|---|---|
| Question ID | Question type | Question Text | format |
| 101 | Personality | “I see myself as | Agreement scale 1-7 |
| | | extraverted and | |
| | | enthusiastic” | |
| 102 | Personality | “I feel comfortable | Agreement scale 1-7 |
| | | in social | |
| | | situations” | |
| 401 | Grades | “What is your | Letter grade A+ to F |
| | | current grade in | |
| | | Algebra 1?” | |
| . . . | . . . | . . . | . . . |

The recommendations information database 128 can include the activities database 128A that includes information about various activities that may be considered for recommendation to the user, including the set of activity information descriptive of a plurality of activities and associated activity correlation information. The activities engine 180A can communicate with the activities database 128A to obtain the set of recommended activities 280A for the user based on the profile 206 of the user and the activity correlation information.

The recommendations information database 128 can also include a study areas database 128B that includes information about various study areas that may be considered for recommendation to the user, including the set of study area information descriptive of a plurality of study areas and associated study area correlation information. The study areas engine 180B can communicate with the study areas database 128B to obtain the set of recommended study areas 280B for the user based on the profile 206 of the user and the study area correlation information. In some aspects, the study area correlation information can also incorporate correlations between study areas and the set of recommended activities 280A (e.g., if a user is recommended a particular high school activity, then the set of recommended study areas for college may include degrees that are related to or that use skills associated with the particular high school activity).

The recommendations information database 128 can also include a careers database 128C that includes information about various careers that may be considered for recommendation to the user, including the set of careers information descriptive of a plurality of careers and associated careers correlation information for correlating aspects of the profile 206 of the user to obtain the set of recommended careers 280C for the user. The careers engine 180C can communicate with the careers database 128C to obtain the set of recommended careers 280C for the user based on the profile 206 of the user and the career correlation information. In some aspects, the career correlation information can also incorporate other sets of recommendations, such as the set of recommended study areas 280B (e.g., if a student is recommended a particular study area, then the set of recommended careers can include careers where the student may benefit from having a degree within the particular study area).

The recommendations database 128 can also include a learning institutions database 128D that includes information about various learning institutions that may be considered for recommendation to the user, including the set of learning institution information descriptive of a plurality of learning institutions and associated learning institution correlation information. The learning institutions engine 180D can communicate with the learning institutions database 128D to obtain the set of recommended learning institutions 280D for the user based on the profile 206 of the user and the learning institution correlation information. In some aspects, the learning institution correlation information can also incorporate other sets of recommendations, such as the set of recommended study areas 280B and the set of recommended careers 280C (e.g., if a student is recommended a particular study area and/or a particular career, then the set of recommended learning institutions may include schools that are particularly known for having high-quality education with respect to that study area and/or career).

### Feedback Engine

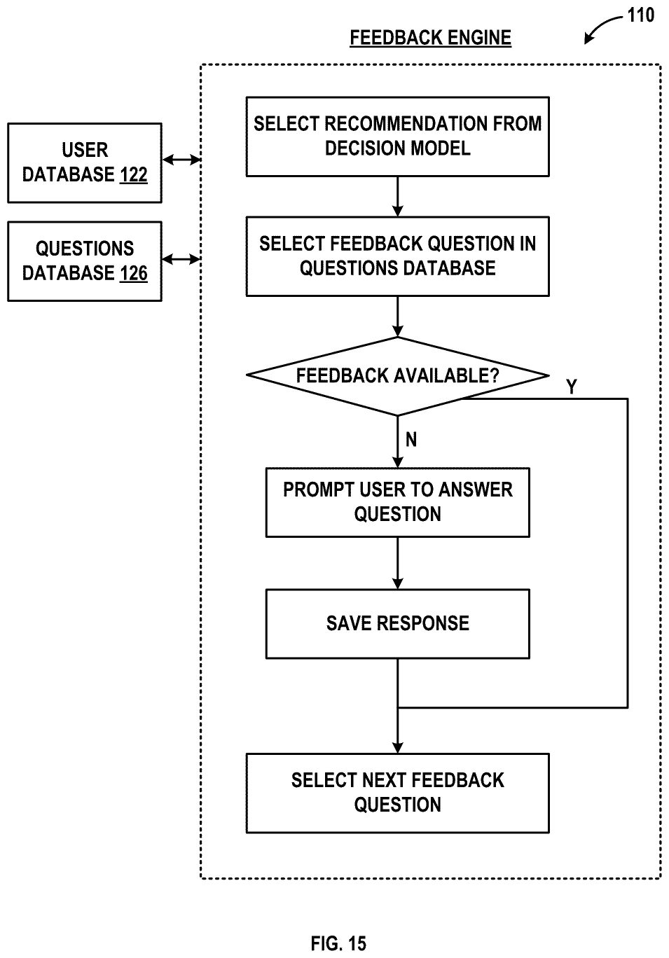

FIG. 15 displays the functionality of the Feedback Engine 110. The process may begin with the feedback engine 110 being initiated by the user. The user may select an option within the user interface 190, such as “Feedback” or “Give Feedback.” The feedback engine 110 may be initiated directly by interacting with a recommendation. The feedback engine 110 may prompt the user to select a recommendation to give feedback on. If the user initiated the feedback engine 110 directly from a displayed recommendation, that recommendation might be automatically selected. The feedback engine 110 may select a question from the question database 126 that is a feedback question. These questions will ask the user to give feedback on a recommendation. Feedback questions may be general or specific to each recommendation. The feedback engine 110 may only select feedback questions specific to the selected recommendation. The feedback engine 110 may determine if this user has an answer in the user database 122 for the selected question. Users may be able to edit previous answers if they choose. If the user has not already answered the question or wants to change their answer, the feedback engine 110 may prompt the user to answer the question. The options for the answer are based on the question-answer format in the question database 126. For example, a feedback question is likely to have the user answer by agreeing or disagreeing with a statement such as “I enjoyed this activity.” The user may have various answers from “Strongly Disagree” to “Strongly Agree.” Feedback questions may be set up such that they cannot be answered until certain effort thresholds are met, such as trying the recommended activity once, trying the recommended activity for 6 months, studying the recommended major for a year, working in the recommended career field for 3 years, etc. For example, a user may need to answer the question, “How long have you been playing basketball?” Further questions may be asked depending on the answer. The feedback engine 110 may record the user's answer in the user database 122. If the feedback question could apply to more than one recommendation, the selected recommendation may be included as part of the answer. The feedback engine 110 may determine if there is another question in the question database 126 that is a feedback question. If the user has not met the effort threshold for a feedback question, that question may be ignored by the feedback engine 110. If there is another feedback question, the feedback engine 110 may select the next question. If there are no other feedback questions, the feedback engine 110 may end. Further, the feedback engine 110 may provide input fields where a user can enter comments about the set of recommendations provided to them—these comments can be subjected to natural language processing methods to extract concepts and provide additional context to feedback provided by the user.

### Training Engine

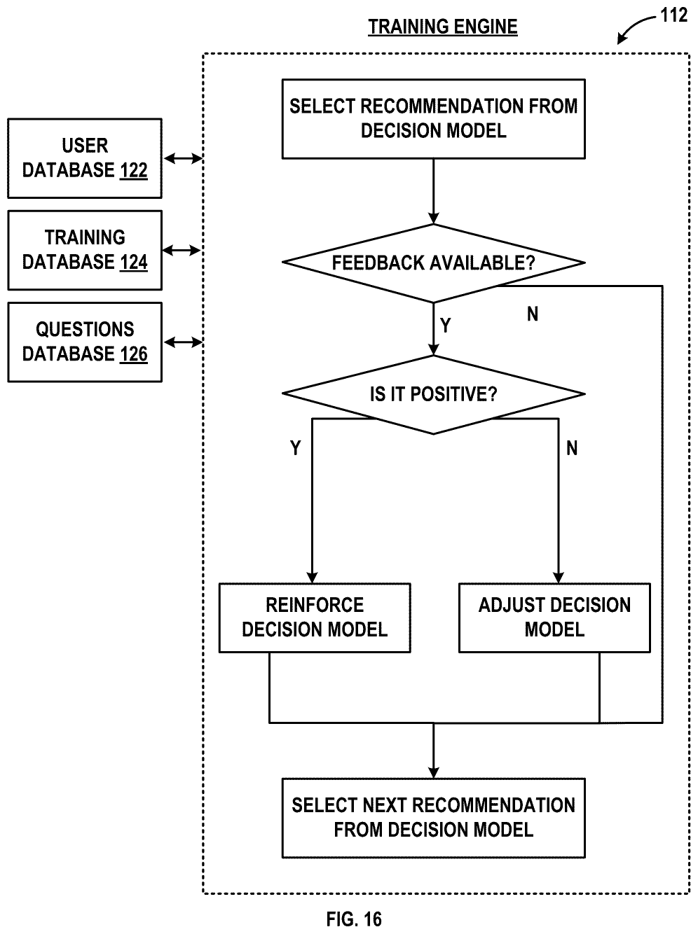

FIG. 16 displays the functioning of the “Training Engine” 112. The process may begin with the training engine 112 polling for new data in the user database 122 or training database 124. The training engine 112 may select the first data entry in the database where the new data was found. Alternatively, the training engine 112 may select entries from both databases each time new data is found. The training engine 112 may input the answer data from the selected entry into a machine-learning model (e.g., of activities decision model 182A shown in FIG. 6, study areas decision model 182B shown in FIG. 8, careers decision model 182C shown in FIG. 10, and/or learning institutions decision model 182D shown in FIG. 12). This data may be the direct answers to the questions or a total score assigned for a category of questions such as one of the OCEAN personality factors, EQ, PQ, etc. The training engine 112 may select the first recommendation output by the machine learning model from the input data. This may include the set of recommendations 208 (FIG. 5), which can encompass the set of recommended activities 280A shown in FIG. 6, the set of recommended study areas 280B shown in FIG. 8, the set of recommended careers 280C shown in FIG. 10 and/or the set of recommended learning institutions 280D shown in FIG. 12. The set of recommendations 208 may be an output by a single machine learning model, or each set (e.g., the set of recommended activities 280A shown in FIG. 6, the set of recommended study areas 280B shown in FIG. 8, the set of recommended careers 280C shown in FIG. 10 and/or the set of recommended learning institutions 280D shown in FIG. 12) may each have their own independently-trained machine learning model.

The training engine 112 may determine if there is feedback in the selected entry for the selected recommendation. Feedback may refer to answers to feedback questions asked to a user. For example, a user may be asked a feedback question such as “On a scale of 1 to 10, how much have you enjoyed playing basketball”. Feedback may refer to measurable metrics of success. For example, data in the training database 124 may include class rankings for people by college major. If there is feedback for the selected recommendation, the training engine 112 may determine if the feedback in the selected entry for the selected recommendation is positive. For example, a user may be asked a feedback question such as “On a scale of 1 to 10, how much have you enjoyed playing basketball”. User answers above 5 may be considered positive feedback, and answers 5 or below may be considered negative feedback. For another example, data in the training database 124 may include class rankings for people by college major. Class rankings in the top 50% may be considered positive feedback, and class rankings in the bottom 50% may be considered negative feedback. Feedback may be neutral. For example, a user may be asked a feedback question such as “On a scale of 1 to 10, how much have you enjoyed playing basketball”. Answers within the range of 4-6 may be considered neutral.

If the feedback for the selected recommendation is positive, the training engine 112 may reinforce the machine learning model or portion of the machine learning model used to make the recommendation. Reinforcement may cause the machine learning model to be more likely to return the same output recommendation for the same or similar inputs. For example, user Bob was recommended a school with a good networking reputation because he is very outgoing and it would benefit his pursuit of a business career. This school was recommended over other more prestigious schools because of Bob's high EQ score. Bob decides to attend school. Bob networks very well at the school, which greatly benefits his business career. When asked to give feedback, Bob responds positively to questions about the school, whether the recommendation was helpful, whether the school helped Bob in his career, etc. Due to this feedback, the machine learning model is adjusted such that the school is more likely to be recommended or ranked higher on a list of recommendations for users with a high EQ. Having a database of the EQ score of users like Bob, and then a database of schools that are ranked by emotional levels (e.g., outgoing activities, social events, network events, etc.) and another database of surveys based on EQ for users like Bob and having a database of correlations (e.g., career value questions, grades) the correlated data from these databases to evaluate initial recommendations to final results to update the ML correlations database (learning) for new recommendations using these databases. If the machine learning model is a neural network, for example, this may be achieved by increasing the weights between active nodes when making the selected recommendation. These changes may be scaled based on how positive the feedback is. For example, a user may be asked a feedback question such as “On a scale of 1 to 10, how much have you enjoyed playing basketball”. An answer of 10 may result in more reinforcement than an answer of 7.

If the feedback for the selected recommendation is not positive, the training engine 112 may adjust the machine learning model or portion of the machine learning model used to make the recommendation. Adjustment may cause the algorithm to be less likely to return the same output recommendation for the same or similar inputs. For example, user Amy was recommended to study a foreign language because of a high openness score based on answers to personality questions. Amy has a C in English and decides to take a foreign language class. Amy enjoys her foreign language class, but her grades in English begin to drop due to studying two different languages. Due to this feedback, the machine learning model is adjusted such that learning a foreign language is less likely to be recommended or ranked lower on a list of recommendations for users with middle to low grades in English. Having a database of the EQ score of users like Amy, and then a database of activities that are ranked by school grades (e.g., math, English, history, etc.) and another database of surveys based on school grades for users like Amy and having a database of correlations (e.g., career value questions, grades) the correlated data from these databases to evaluate initial recommendations to final results to update the ML correlations database (learning) for new recommendations using these databases. If the machine learning model is a neural network, for example, this may be achieved by decreasing the weights between active nodes when making the selected recommendation or by making random changes to nodes that were not used when making the recommendation. These changes may be scaled based on how negative the feedback is. For example, a user may be asked a feedback question such as “On a scale of 1 to 10, how much have you enjoyed playing basketball”. An answer of 1 may result in more adjustment than an answer of 3.

The training engine 112 may determine if the machine learning model has another recommendation output for the selected entry. If there is another recommendation, the training engine 112 may select the next recommendation. If there are no more recommendations, the training engine 112 may determine if there is another entry in the database where the new data was found. If there is another entry, the training engine 112 may select the next entry.

### Machine Learning Model Implementation Examples

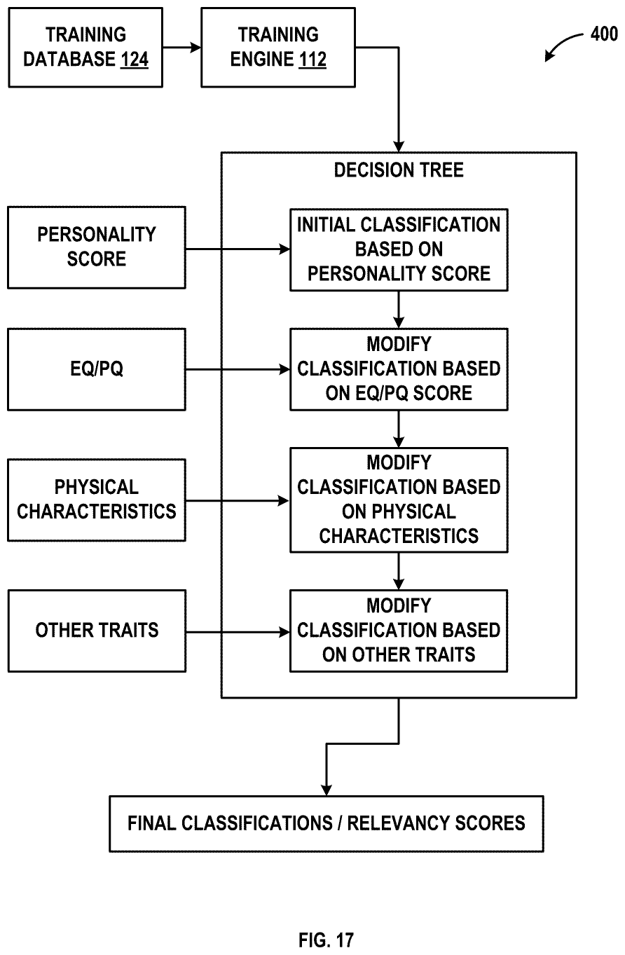

FIG. 17 shows one example implementation of a machine learning model 400 that may be used as a component of the decision framework 108 (e.g., as a component of activities decision model 182A, study areas decision model 182B, careers decision model 182C and/or learning institutions decision model 182D). In this example, the machine learning model 400 has been trained to recommend one or more study areas to a user based on an associated profile, specifically based on a personality profile. Note that while the implementation example outlined herein shows the machine learning model 400 having a specific structure and outputting the set of recommended study areas, this is but one possible implementation; the machine learning model 400 may be constructed differently, may be trained using different methods, and may be operable to receive additional types of information about the user (demographics, EQ, PQ, etc.) to generate other types of recommendations (e.g., activities, learning institutions, careers, etc.) for the user.

In the example of FIG. 17, the machine learning model 400 can be a decision tree-based neural network model that classifies a user into one or more study areas based on responses to personality-related questions (e.g., such as those stored within question database 126 and administered by the personality profile engine 160A of the profile engine 106). Based on the multi-class nature of the target class (one of 14 general categories of academic majors), a decision tree was used for classification. This implementation of the machine learning model 400 receives raw inputs from users (e.g., responses to questions, correlating with information that may be present within a profile of a user) to be used as features, and determines one or more study area relevancy labels for one or more study areas as they pertain to the user based on the inputs provided by the user. In this simplified example, the one or more study area relevancy labels can be binary classification values (e.g., indicating “yes” or “no” for a study area based on its suitability for the user). The machine learning model 400 can be trained by the training engine 112 using information stored in the training database 124, which may include labeled and unlabeled training data, including information from “training profiles” of one or more “training users”, and further including a ground truth dataset that can include labels for the one or more “training users”). The labels in the ground truth dataset can indicate suitability of one or more study areas (or other items to be recommended, such as activities, careers, and/or learning institutions), and can be in the form of study area relevancy labels for one or more study areas (e.g., indicating a positive classification for suitable study areas and a negative classification for unsuitable study areas) and/or one or more recommended study areas (e.g., a final “target” class indicating a listing of one or more “most relevant” study areas).

In one example implementation, Scikit-learn library was used to develop the machine learning model 400 for decision-tree classification. The features (corresponding to information available within the profile of the user) and target (corresponding to available study areas that may be selected for inclusion in the set of recommended study areas for the user) are as shown in Table 5 below:

TABLE 5

| Feature List | Target |
|---|---|
| gender, | Management, Business, Health Service Law/ |
| 10 questions asked for | Administration, Education Engineering, |
| personality traits | Social and Behavioural Science Life |
| questionnaire | Science, Language and Literature |
| | Vocational, Arts, Communication & Media |
| | Physical Science, Philosophy & Theology |

The decision tree is also affected by the depth of the tree—hence, during development, the implementation of the machine learning model 400 was benchmarked with the decision tree depth being varied from 1 to 100 to find an optimal tree depth. The decision tree implementation of the machine learning model 400 is found to perform quite well at a depth of 16, yielding an accuracy of 0.959 when compared with a set of ground truth data of the set of training data. While the accuracy may slightly increase for a high depth of the tree; it is desirable to keep the tree as shallow as possible. This implementation was found to have highly diminishing returns for depth over 20. Keeping the tree shallow also ensures that the machine learning model 400 does not suffer from overfitting, keeping the model generalizable.

However, during development, it was found that the larger dataset (using the answers of each TIPI questionnaire as the feature set) to train the machine learning model 400 was found to be time consuming and unnecessary. As such, dimension reduction techniques were explored to determine if accurate classification can be achieved at lower computational and time cost. In machine learning, dimension reduction can be considered a “black box”, and the feature sets derived from a higher dimension to lower dimensions may have no intuitive real-world meaning. In another example implementation of the machine learning model 400, aspects of the personality profile used as input included OCEAN Index, which reduces to five interpretable attributes (as opposed to ten features from the TIPI question set).

The five features derived from social science research in the form of the OCEAN index along with the gender were used as features in this example implementation of the machine learning model 400. The decision tree of the machine learning model 400 considering OCEAN features as input was found to perform well at a depth of 17 having an accuracy of 0.92, and later at depth 20 with an accuracy of 0.95. Here, the number of feature sets was cut in half, reducing computational cost and time consumed, while the accuracy of this machine learning model 400 is still very close to results obtained using the raw data.

A third example implementation of the machine learning model 400 is also explored that uses Scikit-learn's Principal Component Analysis (PCA) for reducing the dimension of user responses into five components. Unlike OCEAN (considered by the second example implementation of the machine learning model 400), PCA-based features do not have a real-world meaning, however, they represent the 10 TIPI questions. In this implementation, data (e.g., responses to personality-based questions) was first fit into PCA to obtain five principal components as features for application as input to the machine learning model 400. Scikit-learn was used to develop decision-tree classification at the machine learning model 400. The decision tree of this implementation of the machine learning model 400 performs well at a depth of 20, yielding an accuracy of 0.94.

A fourth implementation of a machine learning model was developed according to a multi-layer perceptron (MLP)-based deep neural network classification technique. This implementation of the machine learning model optimizes a log-loss function using Limited-memory BGFS, or stochastic gradient descent. The classification task was done using a different solver. This implementation of the machine learning model achieved an accuracy of 0.66 with over 400 hidden neurons. While that is a moderately good result for a 14-class target variable, this was nowhere near the accuracy of the three decision tree implementations of the machine learning model discussed herein. Further, this implementation of the machine learning model took a lot longer to train. In an 8-core 4.4 GHz processor machine, training the neural network with 500 hidden neurons took over 21 minutes, while the decision trees were unusually trained within as little as 10 seconds.

Based on the validation examples and results discussed in this section, the machine learning model 400 implementing a decision tree classifier with the use of OCEAN score as the dimension reduction technique was found to perform well for the task of generating the set of recommended study areas based on personality profile, and also provides an insight that can be used for other use cases. In these validation examples, the decision tree classifier was found to achieve over 90% accuracy with relatively little training data and training time. Other classification techniques like Deep Neural Network (DNN) were also explored; the DNN achieved usable accuracy of about 65 percent and consumed 120× more training time to get that accuracy. Neural networks took over 20 minutes for 500 hidden neurons (with an accuracy of 65 percent), while decision tree classifier training took less than 10 seconds.

The goal of this validation study is not to perform an absolute benchmarking and comparison, but to find a machine learning model configuration that worked best for the limited data that was available at the time. Decision tree was found to perform the best for limited data, but this could change if there is different data, and can be evaluated continuously. For example, other machine learning model configurations may perform better when generating the set of recommendations while considering a large amount of information of different types that may be obtained through the profile engine 106 (e.g., jointly considering not only personality, but also EQ, PQ, grades, physical characteristics, demographics, goals, preferences, and trajectory of the user over time).

Further, the decision tree implementations discussed herein rely on supervised learning—requiring fully-labeled training data to train the machine learning model 400. However, other possible implementations include, for example, unsupervised or semi-supervised learning techniques in which the machine learning model 400 is trained to generate the set of recommendations using semi-labeled data and/or unlabeled data. This may be useful for continuously improving the decision framework 108 over time based on user data, where the outcome of many users may be generally unknown.

In a further aspect, the decision framework 108 can apply preprocessing techniques to data to improve its usefulness and/or accuracy prior to application of the data to the machine learning model 400. For example, the activities engine 180A may receive information from the physical characteristics profile 260E of a user and adjust the information to consider age-grading, growth curve, and/or expected physical characteristics of a user in the future based on those of their parents. In another example, the study areas engine 180B may estimate grades trajectories of a user for future courses based on their past grades in related courses as indicated within the grades profile 260D of the user. In yet another example, the decision framework 108 may receive information from the demographics profile 260F of the user and adjust recommendations for activities and learning institutions accordingly—e.g., adjusting activity recommendations to include activities that may be available to the user based on ZIP code and other demographics data (example: agriculture clubs may be more readily available to students in rural areas while technology and business related clubs may be more readily available to students in urban areas), and adjusting activity and learning institution recommendations based on statistical advantages or disadvantages (example: students at a statistical disadvantage may be recommended one or more activities that may help them gain a competitive “edge”; students from wealthy areas and income levels may be less concerned with selecting an affordable college; students who graduate near the top of their class at a low-performing school may not inherently have the same statistical advantage as students who graduate near the top of their class at an exclusive high-performing school). As such, data obtained from the profile engine 106 may be pre-processed prior to application as input at the one or more machine learning models of the decision framework. Additional pre-processing operations can include application of natural language processing methods to written comments and other inputs associated with the user to extract concepts and add context that may be best expressed through language.

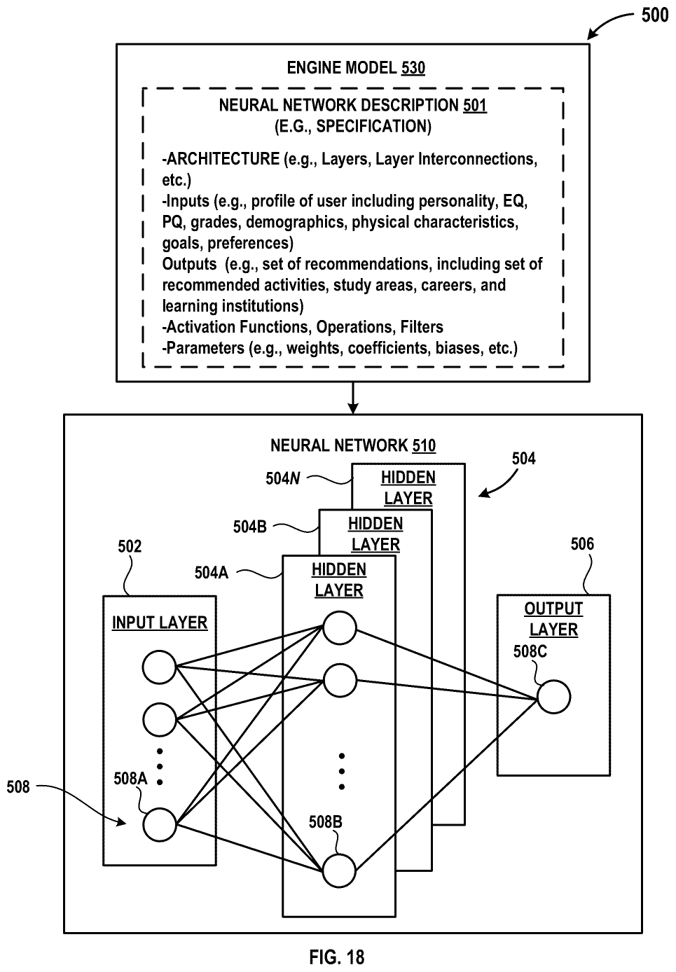

FIG. 18 is a schematic block diagram of an example neural network architecture 500 that may be used with one or more embodiments described herein, e.g., as a component of one or more machine learning models of the decision framework 108 and particularly as a component of activities decision model 182A, study areas decision model 182B, careers decision model 182C and learning institutions decision model 182D to generate the set of recommendations based on the profile of the user. Neural network architecture 500 can be used in place of or in combination with the (decision tree-based) machine learning model 400 of FIG. 17.

Architecture 500 includes a neural network 510 defined by an example neural network description 501 in an engine model (neural controller) 530. The neural network 510 can represent a neural network implementation of the decision framework 108, including one or more of the activities decision model 182A, study areas decision model 182B, careers decision model 182C and learning institutions decision model 182D. The neural network description 501 can include a full specification of the neural network 510, including the neural network architecture 500. For example, the neural network description 501 can include a description or specification of the architecture 500 of the neural network 510 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 510 reflects the architecture 500 defined in the neural network description 501. In an example corresponding to the activities decision model 182A, the neural network 510 includes an input layer 502, which includes input data, such as data indicative of a profile of a user including a personality profile corresponding to one or more nodes 508. In one illustrative example, the input layer 502 can include data representing a portion of input data such as answers responsive to questions presented by the profile engine 106, a set of OCEAN scores representing the personality profile, along with an EQ profile, a PQ profile, a physical characteristics profile, a demographics profile, a grades profile, a preferences profile, and/or a goals profile. Input data can also include data about one or more recommendations stored within the recommendations information database 128, such as information about various activities, study areas, careers, and learning institutions and correlation information that describe correlations between various traits of the user and one or more recommendations, as well as correlations between recommendations (e.g., connections between study areas and careers).

The neural network 510 includes hidden layers 504A through 504N (collectively “504” hereinafter). The hidden layers 504 can include n number of hidden layers, where n is an integer greater than or equal to one. The number of hidden layers can include as many layers as needed for a desired processing outcome and/or rendering intent. The neural network 510 further includes an output layer 506 that provides an output (e.g., set of recommendations including a set of recommended activities, a set of recommended study areas, a set of recommended careers, and/or a set of recommended learning institutions) resulting from the processing performed by the hidden layers 504. In an illustrative example corresponding to the activities decision model 182A, the output layer 506 can provide the set of recommended activities based on the profile of the user provided to the input layer 502.

The neural network 510 in this example is a multi-layer neural network of interconnected nodes. Each node can represent a piece of information. Information associated with the nodes is shared among the different layers and each layer retains information as information is processed. In some cases, the neural network 510 can include a feed-forward neural network, in which case there are no feedback connections where outputs of the neural network are fed back into itself. In other cases, the neural network 510 can include a recurrent neural network, which can have loops that allow information to be carried across nodes while reading in input.

Information can be exchanged between nodes through node-to-node interconnections between the various layers. Nodes of the input layer 502 can activate a set of nodes in the first hidden layer 504A. For example, as shown, each of the input nodes of the input layer 502 is connected to each of the nodes of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of the hidden layer (e.g., 504B) can then activate nodes of the next hidden layer (e.g., 504N), and so on. The output of the last hidden layer can activate one or more nodes of the output layer 506, at which point an output is provided. In some cases, while nodes (e.g., nodes 508A, 508B, 508C) in the neural network 510 are shown as having multiple output lines, a node has a single output and all lines shown as being output from a node represent the same output value.

In some cases, each node or interconnection between nodes can have a weight that is a set of parameters derived from training the neural network 510. For example, an interconnection between nodes can represent a piece of information learned about the interconnected nodes. The interconnection can have a numeric weight that can be tuned (e.g., based on a training dataset), allowing the neural network 510 to be adaptive to inputs and able to learn as more data is processed.

The neural network 510 can be pre-trained to process the features from the data in the input layer 502 using the different hidden layers 504 in order to provide the output through the output layer 506. In an example corresponding to the activities decision model 182A, in which the neural network 510 is used to generate the set of recommended activities based on the profile of the user, the neural network 510 can be trained using training data that includes example profiles and associated activities that are labeled according to suitability for individuals represented within the example profiles. For instance, training data can be input into the neural network 510, which can be processed by the neural network 510 to generate outputs which can be used to tune one or more aspects of the neural network 510, such as weights, biases, etc.

In some cases, the neural network 510 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network 510, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 510 is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. The neural network 510 can perform a backward pass by determining which inputs (weights) most contributed to the loss of the neural network 510, and can adjust the weights so that the loss decreases and is eventually minimized.

A derivative of the loss with respect to the weights can be computed to determine the weights that contributed most to the loss of the neural network 510. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 510 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 510 can represent any other neural or deep learning network, such as an autoencoder, a deep belief nets (DBNs), and recurrent neural networks (RNNs), etc.

### Computer-Implemented Device

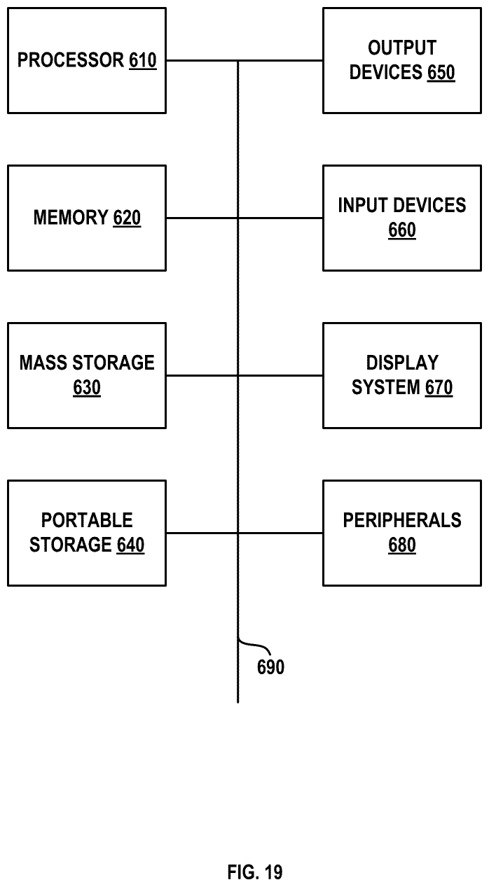

FIG. 19 illustrates an exemplary computing system 600 that may be used to implement an embodiment of the present invention. The computing system 600 of FIG. 19 includes one or more processors 610 and memory 620. Main memory 620 stores, in part, instructions and data for execution by processor 610. Main memory 620 can store the executable code when in operation. The system 600 of FIG. 19 further includes a mass storage device 630, portable storage medium drive(s) 640, output devices 650, user input devices 660, a graphics display 670, and peripheral devices 680.

The components shown in FIG. 19 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disc, to input and output data and code to and from the computer system 600 of FIG. 19. The system software for implementing embodiments of the present invention may be stored on such a portable medium and input to the computer system 600 via the portable storage device 640.

Input devices 660 provide a portion of a user interface. Input devices 660 may include a touch-screen display, an alpha-numeric keypad, such as a keyboard, for inputting alpha-numeric and other information, or a pointing device, such as a mouse, a trackball, stylus, or cursor direction keys. Additionally, the system 600 as shown in FIG. 15 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 19 are those typically found in computer systems that may be suitable for use with embodiments of the present invention and are intended to represent a broad category of such computer components that are well known in the art. Thus, the computer system 600 of FIG. 19 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

### Methods

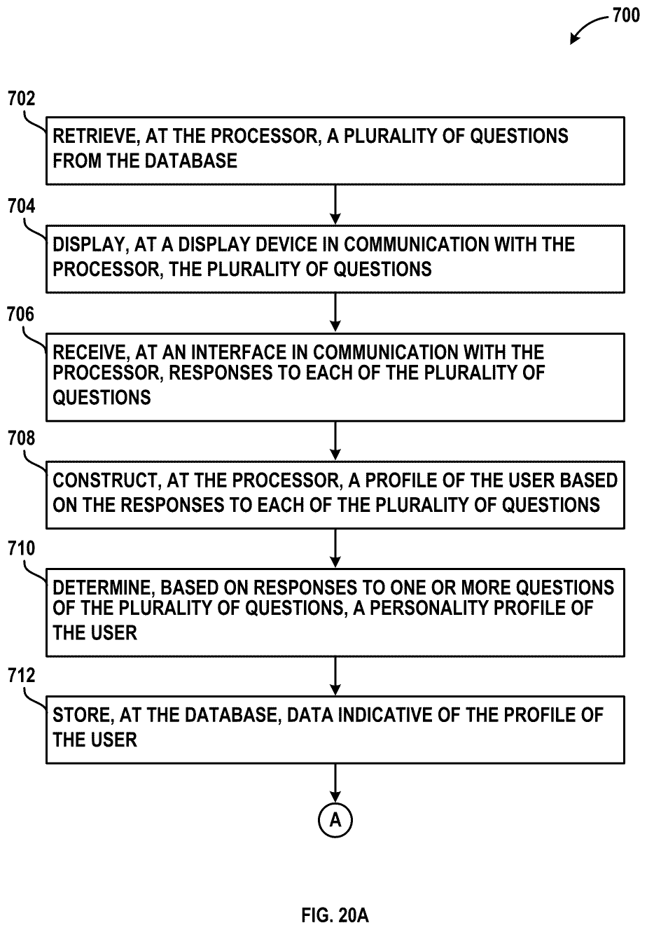

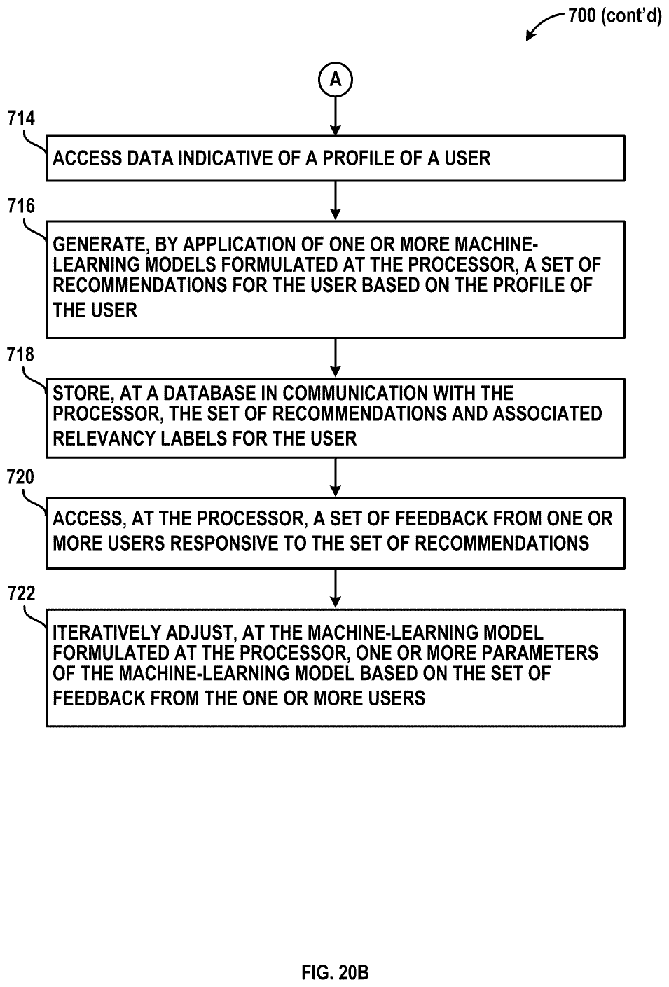

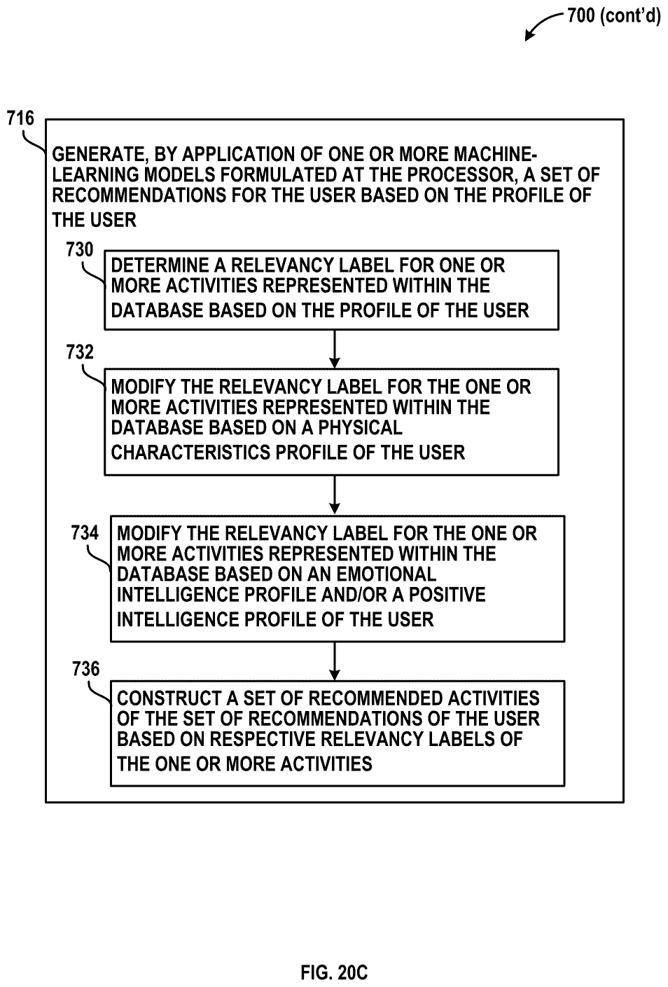

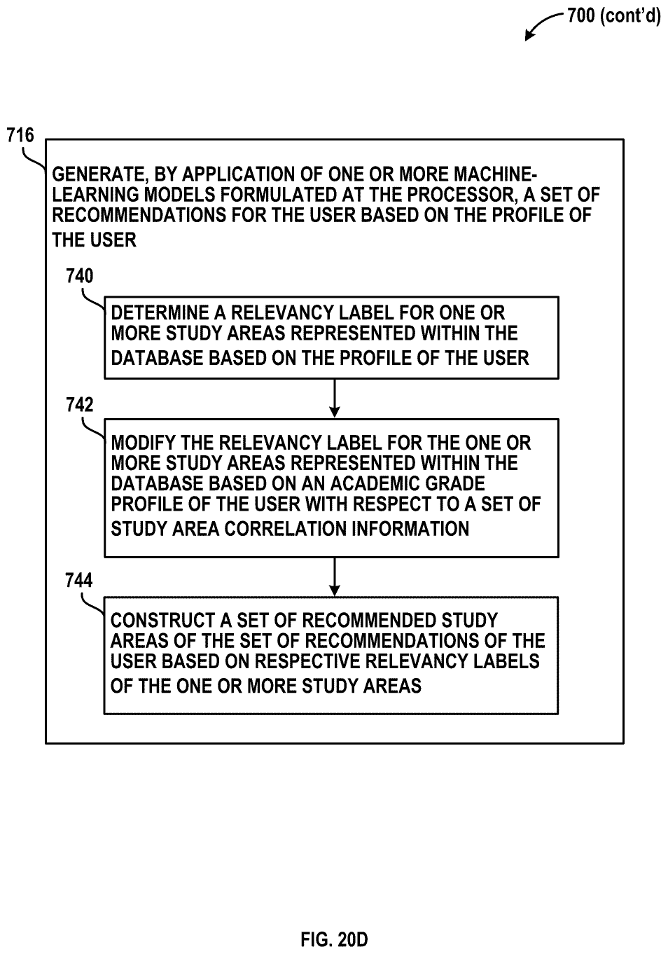

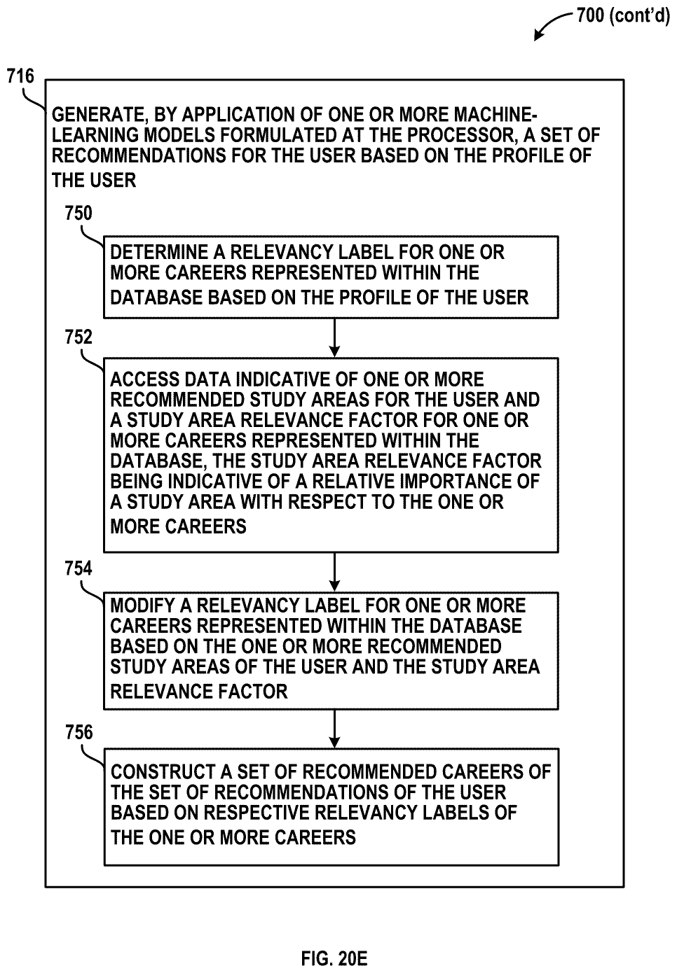

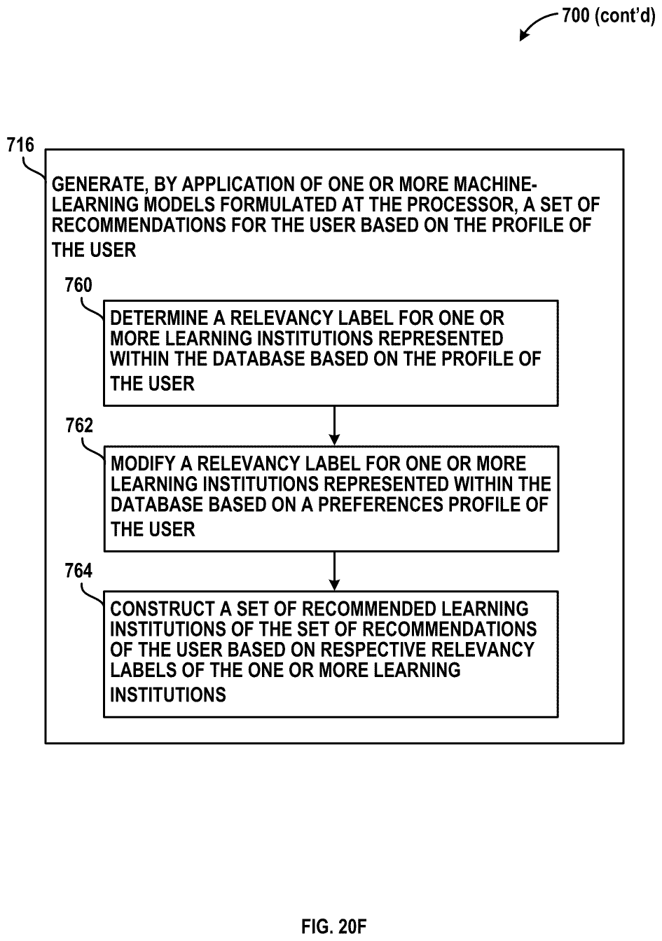

FIGS. 20A-20F illustrate a method 700 for implementation of the system 100 of FIG. 1.

In particular, FIG. 20A illustrates steps for obtaining a profile of the user (e.g., as applied by the profile engine 106 shown in FIG. 3). As shown, method 700 can start at step 702, which includes retrieving, at the processor, a plurality of questions from the database. Step 704 includes displaying, at a display device in communication with the processor, the plurality of questions. Step 706 includes receiving, at an interface in communication with the processor, responses to each of the plurality of questions. Step 708 includes constructing, at the processor, a profile of the user based on the responses to each of the plurality of questions. Step 710 includes determining, based on responses to one or more questions of the plurality of questions, a personality profile of the user. Step 712 includes storing, at the database, data indicative of the profile of the user. FIG. 20A ends at circle A.

FIG. 20B illustrates steps for generating and storing recommendations based on the profile of the user (e.g., steps applied by one or more of: base module 104 shown in FIG. 2, decision framework 108 shown in FIG. 5, and training engine 112 shown in FIG. 16). FIG. 20B begins at circle A. Step 714 includes accessing data indicative of a profile of a user. Step 716 includes generating, by application of one or more machine-learning models formulated at the processor, a set of recommendations for the user based on the profile of the user. Step 718 includes storing, at a database in communication with the processor, the set of recommendations and associated relevancy labels for the user. Step 720 includes accessing, at the processor, a set of feedback from one or more users responsive to the set of recommendations. Step 722 includes iteratively adjusting, at the machine-learning model formulated at the processor, one or more parameters of the machine-learning model based on the set of feedback from the one or more users.

FIGS. 20C-20F illustrate various sub-steps of step 716 of FIG. 20B directed to generating the set of recommendations for the user based on the profile of the user (e.g., as applied by decision framework 108 shown in FIG. 5). In particular, FIG. 20C shows steps taken to generate a set of recommended activities (e.g., as applied by activities engine 180A shown in FIG. 6), FIG. 20D shows steps taken to generate a set of recommended study areas (e.g., as applied by study areas engine 180B shown in FIG. 8), FIG. 20E shows steps taken to generate a set of recommended careers (e.g., as applied by careers engine 180C shown in FIG. 10), and FIG. 20F shows steps taken to generate a set of recommended learning institutions (e.g., as applied by learning institutions engine 180D shown in FIG. 12). Steps outlined in FIGS. 20C-20F can be applied during execution of step 716 of FIG. 20B, and can in some embodiments be applied simultaneously or in a pre-determined sequence.

As shown in FIG. 20C, step 716 includes various sub-steps for generating the set of recommended activities (e.g., as applied by activities engine 180A shown in FIG. 6). Step 716 can include step 730 which includes determining a relevancy label for one or more activities represented within the database based on the profile of the user—this can include determining a relevancy label for one or more activities represented within the database based on a personality profile of the user. Step 732 includes modifying the relevancy label for the one or more activities represented within the database based on a physical characteristics profile of the user. Step 734 includes modifying the relevancy label for the one or more activities represented within the database based on an emotional intelligence profile and/or a positive intelligence profile of the user. Step 736 includes constructing a set of recommended activities of the set of recommendations of the user based on respective relevancy labels of the one or more activities. Additional steps can include modifying the relevancy label for the one or more activities represented within the database based on one or more of: a grades profile, a demographics profile, a goals profile, and/or a preferences profile; and can further include modifying the set of recommended activities of the set of recommendations of the user based on respective relevancy labels of the one or more activities.

As shown in FIG. 20D, step 716 includes various sub-steps for generating the set of recommended study areas (e.g., as applied by study areas engine 180B shown in FIG. 8). Step 716 can include step 740 which includes determining a relevancy label for one or more study areas represented within the database based on the profile of the user—this can include determining a relevancy label for one or more study areas represented within the database based on a personality profile of the user. Step 742 includes modifying the relevancy label for the one or more study areas represented within the database based on a grades profile of the user with respect to a set of study area correlation information. Step 744 includes constructing a set of recommended study areas of the set of recommendations of the user based on respective relevancy labels of the one or more study areas. Additional steps can include modifying the relevancy label for the one or more study areas represented within the database based on one or more of: an emotional intelligence profile and/or a positive intelligence profile, a physical characteristics profile, a demographics profile, a goals profile, and/or a preferences profile; and can further include modifying the set of recommended study areas of the set of recommendations of the user based on respective relevancy labels of the one or more study areas.

As shown in FIG. 20E, step 716 includes various sub-steps for generating the set of recommended careers (e.g., as applied by careers engine 180C shown in FIG. 10). Step 716 can include step 750 which includes determining a relevancy label for one or more careers represented within the database based on the profile of the user—this can include determining a relevancy label for one or more careers represented within the database based on a personality profile of the user. Step 752 includes accessing data indicative of one or more recommended study areas for the user and a study area relevance factor for one or more careers represented within the database, the study area relevance factor being indicative of a relative importance of a study area with respect to the one or more careers. This step ensures that careers recommended to the user are in alignment with study areas the user may choose to pursue. Step 754 includes modifying the relevancy label for the one or more careers represented within the database based on the one or more recommended study areas of the user and the study area relevance factor. Step 756 includes constructing a set of recommended careers of the set of recommendations of the user based on respective relevancy labels of the one or more careers. Additional steps can include modifying the relevancy label for the one or more careers represented within the database based on one or more of: an emotional intelligence profile and/or a positive intelligence profile, a physical characteristics profile, a grades profile, a demographics profile, a goals profile, and/or a preferences profile; and can further include modifying the set of recommended careers of the set of recommendations of the user based on respective relevancy labels of the one or more careers.

As shown in FIG. 20D, step 716 includes various sub-steps for generating the set of recommended learning institutions (e.g., as applied by learning institutions engine 180D shown in FIG. 12). Step 716 can include step 760 which includes determining a relevancy label for one or more learning institutions represented within the database based on the profile of the user—this can include determining a relevancy label for one or more learning institutions represented within the database based on a personality profile, demographics profile, set of recommended study areas, and/or set of recommended careers of the user. Step 762 includes modifying the relevancy label for the one or more learning institutions represented within the database based on a preferences profile of the user. Step 764 includes constructing a set of recommended learning institutions of the set of recommendations of the user based on respective relevancy labels of the one or more learning institutions. Additional steps can include modifying the relevancy label for the one or more learning institutions represented within the database based on one or more of: an emotional intelligence profile and/or a positive intelligence profile, and a goals profile; and can further include modifying the set of recommended learning institutions of the set of recommendations of the user based on respective relevancy labels of the one or more learning institutions.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a processor in communication with a memory and including instructions executable by the processor to:
access data indicative of a profile of a user;
generate, by application of one or more machine-learning models formulated at the processor, a set of recommendations for the user based on the profile of the user; and
store, at a database in communication with the processor, the set of recommendations and associated relevancy labels for the user.

2. The system of claim 1, the memory further including instructions executable by the processor to:
determine a relevancy label for one or more activities represented within the database based on the profile of the user; and
construct a set of recommended activities of the set of recommendations of the user based on respective relevancy labels of the one or more activities.

3. The system of claim 2, the memory further including instructions executable by the processor to:
modify the relevancy label for the one or more activities represented within the database based on a physical characteristics profile of the user.

4. The system of claim 2, the memory further including instructions executable by the processor to:
modify the relevancy label for the one or more activities represented within the database based on an emotional intelligence profile and/or a positive intelligence profile of the user.

5. The system of claim 1, the memory further including instructions executable by the processor to:
determine a relevancy label for one or more study areas represented within the database based on the profile of the user; and
construct a set of recommended study areas of the set of recommendations of the user based on respective relevancy labels of the one or more study areas.

6. The system of claim 5, the memory further including instructions executable by the processor to:
modify the relevancy label for the one or more study areas represented within the database based on an academic grade profile of the user with respect to a set of study area correlation information.

7. The system of claim 1, the memory further including instructions executable by the processor to:
determine a relevancy label for one or more careers represented within the database based on the profile of the user; and
construct a set of recommended careers of the set of recommendations of the user based on respective relevancy labels of the one or more careers.

8. The system of claim 7, the memory further including instructions executable by the processor to:
access data indicative of one or more recommended study areas for the user and a study area relevance factor for one or more careers represented within the database, the study area relevance factor being indicative of a relative importance of a study area with respect to the one or more careers; and
modify a relevancy label for one or more careers represented within the database based on the one or more recommended study areas of the user and the study area relevance factor.

9. The system of claim 1, the memory further including instructions executable by the processor to:
determine a relevancy label for one or more learning institutions represented within the database based on the profile of the user; and
construct a set of recommended learning institutions of the set of recommendations of the user based on respective relevancy labels of the one or more learning institutions.

10. The system of claim 9, the memory further including instructions executable by the processor to:
modify a relevancy label for one or more learning institutions represented within the database based on a preferences profile of the user.

11. The system of claim 1, the memory further including instructions executable by the processor to:
retrieve, at the processor, a plurality of questions from the database;
display, at a display device in communication with the processor, the plurality of questions;
receive, at an interface in communication with the processor, responses to each of the plurality of questions;
construct, at the processor, a profile of the user based on the responses to each of the plurality of questions; and
store, at the database, data indicative of the profile of the user.

12. The system of claim 11, the memory further including instructions executable by the processor to:
determine, based on responses to one or more questions of the plurality of questions, a personality profile of the user.

13. The system of claim 1, the memory further including instructions executable by the processor to:
access, at the processor, a set of feedback from one or more users responsive to the set of recommendations; and
iteratively adjust, at the one or more machine-learning models formulated at the processor, one or more parameters of the one or more machine-learning models based on the set of feedback from the one or more users.

14. A method comprising:
accessing, at a processor in communication with a memory, data indicative of a profile of a user;
generating, by application of one or more machine-learning models formulated at the processor, a set of recommendations for the user based on the profile of the user; and
storing, at a database in communication with the processor, the set of recommendations and associated relevancy labels for the user.

15. The method of claim 14, further comprising:
determining a relevancy label for one or more activities represented within the database based on the profile of the user; and
constructing a set of recommended activities of the set of recommendations of the user based on respective relevancy labels of the one or more activities.

16. The method of claim 14, further comprising:
determining a relevancy label for one or more study areas represented within the database based on the profile of the user; and
constructing a set of recommended study areas of the set of recommendations of the user based on respective relevancy labels of the one or more study areas.

17. The method of claim 14, further comprising:
determining a relevancy label for one or more careers represented within the database based on the profile of the user; and
constructing a set of recommended careers of the set of recommendations of the user based on respective relevancy labels of the one or more careers.

18. The method of claim 14, further comprising:
determining a relevancy label for one or more learning institutions represented within the database based on the profile of the user; and
constructing a set of recommended learning institutions of the set of recommendations of the user based on respective relevancy labels of the one or more learning institutions.

19. The method of claim 14, further comprising:
retrieving, at the processor, a plurality of questions from the database;
displaying, at a display device in communication with the processor, the plurality of questions;
receiving, at an interface in communication with the processor, responses to each of the plurality of questions;
constructing, at the processor, a profile of the user based on the responses to each of the plurality of questions; and
storing, at the database, data indicative of the profile of the user.

20. A non-transitory computer-readable storage medium having instructions embodied thereon, the instructions executable by a computing system to perform a method for generating a set of recommendations for educational goals based on a profile of a user, the method comprising:
accessing data indicative of a profile of a user;
generating, by application of one or more machine-learning models, a set of recommendations for the user based on the profile of the user; and
storing, at a database, the set of recommendations and associated relevancy labels for the user.
